(19) United States
(12) Patent Application Publication
(10) Pub. No.: US 2025/0166133 A1
(43) Pub. Date: May 22, 2025

(54) MODIFYING VIDEO CONTENT

(71) Applicant: QUALCOMM Incorporated, San Diego, CA (US)

(72) Inventors: Kumara KAHATAPITIYA, Amsterdam (NL); Davide ABATI, Amsterdam (NL); Amirhossein HABIBIAN, Amsterdam (NL); Yuki ASANO, Amsterdam (NL)

(21) Appl. No.: 18/596,543

(22) Filed: Mar. 5, 2024

Related U.S. Application Data
(60) Provisional application No. 63/599,988, filed on Nov. 16, 2023.

(51) Int. Cl. G06T 5/60; G06T 5/50

(52) U.S. Cl. CPC G06T 5/60; G06T 5/50; G06T 2207/10016; G06T 2207/20221

(57) ABSTRACT

Systems and techniques are described herein for modifying video data. For instance, a method for modifying video data is provided. The method may include obtaining first tokens based on a first frame of video data, wherein each of the first tokens comprises a feature vector corresponding to a respective location within the first frame of video data; obtaining second tokens based on a second frame of video data, wherein each of the second tokens comprises a feature vector corresponding to a respective location within the second frame of video data; determining a destination token from among the first tokens; determining candidate tokens from among the second tokens based on respective relationships between the candidate tokens and the destination token; merging the candidate tokens with the destination token resulting in modified second tokens; and processing the modified second tokens using a diffusion model.

### CROSS-REFERENCE TO RELATED APPLICATIONS

This application claims priority to U.S. Provisional Patent Application No. 63/599,988, filed Nov. 16, 2023, which is hereby incorporated by reference, in its entirety and for all purposes.

### TECHNICAL FIELD

The present disclosure generally relates to processing video content. For example, aspects of the present disclosure include systems and techniques for modifying video content.

### BACKGROUND

Video content may be modified by modifying frames of images data (e.g., one frame of a video at a time). In some cases, a machine-learning model may be trained to modify video content. For example, a latent diffusion model may be used to modify frames of video data (e.g., to replace an object in a frame of video data with a different object).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for modifying video data. According to at least one example, a method is provided for modifying video data. The method includes: obtaining first tokens based on a first frame of video data, wherein each of the first tokens comprises a feature vector corresponding to a respective location within the first frame of video data; obtaining second tokens based on a second frame of video data, wherein each of the second tokens comprises a feature vector corresponding to a respective location within the second frame of video data; determining a destination token from among the first tokens; determining candidate tokens from among the second tokens based on respective relationships between the candidate tokens and the destination token; merging the candidate tokens with the destination token resulting in modified second tokens; and processing the modified second tokens using a diffusion model.

In another example, an apparatus for modifying video data is provided. The apparatus includes one or more memories and one or more processors (e.g., configured in circuitry) coupled to the one or more memories. The one or more processors are configured to: obtain first tokens based on a first frame of video data, wherein each of the first tokens comprises a feature vector corresponding to a respective location within the first frame of video data; obtain second tokens based on a second frame of video data, wherein each of the second tokens comprises a feature vector corresponding to a respective location within the second frame of video data; determine a destination token from among the first tokens; determine candidate tokens from among the second tokens based on respective relationships between the candidate tokens and the destination token; merge the candidate tokens with the destination token resulting in modified second tokens; and process the modified second tokens using a diffusion model.

In another example, a non-transitory computer-readable medium is provided that has stored thereon instructions that, when executed by one or more processors, cause the one or more processors to: obtain first tokens based on a first frame of video data, wherein each of the first tokens comprises a feature vector corresponding to a respective location within the first frame of video data; obtain second tokens based on a second frame of video data, wherein each of the second tokens comprises a feature vector corresponding to a respective location within the second frame of video data; determine a destination token from among the first tokens; determine candidate tokens from among the second tokens based on respective relationships between the candidate tokens and the destination token; merge the candidate tokens with the destination token resulting in modified second tokens; and process the modified second tokens using a diffusion model.

In another example, an apparatus for modifying video data is provided. The apparatus includes: means for obtaining first tokens based on a first frame of video data, wherein each of the first tokens comprises a feature vector corresponding to a respective location within the first frame of video data; means for obtaining second tokens based on a second frame of video data, wherein each of the second tokens comprises a feature vector corresponding to a respective location within the second frame of video data; means for determining a destination token from among the first tokens; means for determining candidate tokens from among the second tokens based on respective relationships between the candidate tokens and the destination token; means for merging the candidate tokens with the destination token resulting in modified second tokens; and means for processing the modified second tokens using a diffusion model.

In another example, a method is provided for modifying video data. The method includes: obtaining a plurality of tokens comprising a respective set of tokens for each frame of a plurality of frames of video data; identifying a destination token from among the plurality of tokens; determining candidate tokens from among the plurality of tokens based on respective relationships between the candidate tokens and the destination token; merging the candidate tokens with the destination token resulting in modified second tokens; and processing the modified second tokens using a diffusion model.

In another example, an apparatus for modifying video data is provided. The apparatus includes one or more memories and one or more processors (e.g., configured in circuitry) coupled to the one or more memories. The one or more processors are configured to: obtain a plurality of tokens comprising a respective set of tokens for each frame of a plurality of frames of video data; identify a destination token from among the plurality of tokens; determine candidate tokens from among the plurality of tokens based on respective relationships between the candidate tokens and the destination token; merge the candidate tokens with the destination token resulting in modified second tokens; and process the modified second tokens using a diffusion model.

In another example, a non-transitory computer-readable medium is provided that has stored thereon instructions that, when executed by one or more processors, cause the one or more processors to: obtain a plurality of tokens comprising a respective set of tokens for each frame of a plurality of frames of video data; identify a destination token from among the plurality of tokens; determine candidate tokens from among the plurality of tokens based on respective relationships between the candidate tokens and the destination token; merge the candidate tokens with the destination token resulting in modified second tokens; and process the modified second tokens using a diffusion model.

In another example, an apparatus for modifying video data is provided. The apparatus includes: means for obtaining a plurality of tokens comprising a respective set of tokens for each frame of a plurality of frames of video data; manes for identifying a destination token from among the plurality of tokens; means for determining candidate tokens from among the plurality of tokens based on respective relationships between the candidate tokens and the destination token; means for merging the candidate tokens with the destination token resulting in modified second tokens; and means for processing the modified second tokens using a diffusion model.

In another example, a method is provided for modifying image data. The method includes: obtaining tokens based on image data, wherein each of the tokens comprises a feature vector corresponding to a respective location within the image data; determining a destination token from among the tokens; obtaining a segmentation mask based on the image data; determining candidate tokens from among the tokens based on respective relationships between the candidate tokens and the destination token and based on the segmentation mask; merging the candidate tokens with the destination token resulting in modified tokens; and processing the modified tokens using a diffusion model.

In another example, an apparatus for modifying image data is provided. The apparatus includes one or more memories and one or more processors (e.g., configured in circuitry) coupled to the one or more memories. The one or more processors are configured to: obtain tokens based on image data, wherein each of the tokens comprises a feature vector corresponding to a respective location within the image data; determine a destination token from among the tokens; obtain a segmentation mask based on the image data; determine candidate tokens from among the tokens based on respective relationships between the candidate tokens and the destination token and based on the segmentation mask; merge the candidate tokens with the destination token resulting in modified tokens; and process the modified tokens using a diffusion model.

In another example, a non-transitory computer-readable medium is provided that has stored thereon instructions that, when executed by one or more processors, cause the one or more processors to: obtain tokens based on image data, wherein each of the tokens comprises a feature vector corresponding to a respective location within the image data; determine a destination token from among the tokens; obtain a segmentation mask based on the image data; determine candidate tokens from among the tokens based on respective relationships between the candidate tokens and the destination token and based on the segmentation mask; merge the candidate tokens with the destination token resulting in modified tokens; and process the modified tokens using a diffusion model.

In another example, an apparatus for modifying image data is provided. The apparatus includes: means for obtaining tokens based on image data, wherein each of the tokens comprises a feature vector corresponding to a respective location within the image data; means for determining a destination token from among the tokens; means for obtaining a segmentation mask based on the image data; means for determining candidate tokens from among the tokens based on respective relationships between the candidate tokens and the destination token and based on the segmentation mask; means for merging the candidate tokens with the destination token resulting in modified tokens; and means for processing the modified tokens using a diffusion model.

In another example, a method is provided for modifying image data. The method includes: identifying a first portion of image data and a second portion of the image data based on a segmentation mask; processing the first portion of the image data using a diffusion model to generate a modified first portion of the image data; and generating modified image data based on the modified first portion of the image data and the second portion of the image data.

In another example, an apparatus for modifying image data is provided. The apparatus includes one or more memories and one or more processors (e.g., configured in circuitry) coupled to the one or more memories. The one or more processors are configured to: identify a first portion of image data and a second portion of the image data based on a segmentation mask; process the first portion of the image data using a diffusion model to generate a modified first portion of the image data; and generate modified image data based on the modified first portion of the image data and the second portion of the image data.

In another example, a non-transitory computer-readable medium is provided that has stored thereon instructions that, when executed by one or more processors, cause the one or more processors to: identify a first portion of image data and a second portion of the image data based on a segmentation mask; process the first portion of the image data using a diffusion model to generate a modified first portion of the image data; and generate modified image data based on the modified first portion of the image data and the second portion of the image data.

In another example, an apparatus for modifying image data is provided. The apparatus includes: means for identifying a first portion of image data and a second portion of the image data based on a segmentation mask; means for processing the first portion of the image data using a diffusion model to generate a modified first portion of the image data; and means for generating modified image data based on the modified first portion of the image data and the second portion of the image data

In another example, a method is provided for modifying image data. The method includes: identifying a first portion of image data and a second portion of the image data based on a segmentation mask; processing the first portion of the image data using a diffusion model to generate a modified first portion of the image data; and combining the modified first portion of the image data and the second portion of the image data resulting in modified image data.

In another example, an apparatus for modifying image data is provided. The apparatus includes one or more memories and one or more processors (e.g., configured in circuitry) coupled to the one or more memories. The one or more processors are configured to: identify a first portion of image data and a second portion of the image data based on a segmentation mask; process the first portion of the image data using a diffusion model to generate a modified first portion of the image data; and combine the modified first portion of the image data and the second portion of the image data resulting in modified image data.

In another example, a non-transitory computer-readable medium is provided that has stored thereon instructions that, when executed by one or more processors, cause the one or more processors to: identify a first portion of image data and a second portion of the image data based on a segmentation mask; process the first portion of the image data using a diffusion model to generate a modified first portion of the image data; and combine the modified first portion of the image data and the second portion of the image data resulting in modified image data.

In another example, an apparatus for modifying image data is provided. The apparatus includes: means for identifying a first portion of image data and a second portion of the image data based on a segmentation mask; means for processing the first portion of the image data using a diffusion model to generate a modified first portion of the image data; and means for combining the modified first portion of the image data and the second portion of the image data resulting in modified image data.

In another example, a method is provided for modifying image data. The method includes: identifying a first portion of image data and a second portion of the image data based on a segmentation mask; processing the first portion of the image data using a first number of diffusion steps of a diffusion model to generate a partially-modified first portion of the image data; and processing the partially-modified first portion of the image data and the second portion of the image data using a second number of diffusion steps of the diffusion model to generate modified image data.

In another example, an apparatus for modifying image data is provided. The apparatus includes one or more memories and one or more processors (e.g., configured in circuitry) coupled to the one or more memories. The one or more processors are configured to: identify a first portion of image data and a second portion of the image data based on a segmentation mask; process the first portion of the image data using a first number of diffusion steps of a diffusion model to generate a partially-modified first portion of the image data; and process the partially-modified first portion of the image data and the second portion of the image data using a second number of diffusion steps of the diffusion model to generate modified image data.

In another example, a non-transitory computer-readable medium is provided that has stored thereon instructions that, when executed by one or more processors, cause the one or more processors to: identify a first portion of image data and a second portion of the image data based on a segmentation mask; process the first portion of the image data using a first number of diffusion steps of a diffusion model to generate a partially-modified first portion of the image data; and process the partially-modified first portion of the image data and the second portion of the image data using a second number of diffusion steps of the diffusion model to generate modified image data.

In another example, an apparatus for modifying image data is provided. The apparatus includes: means for identifying a first portion of image data and a second portion of the image data based on a segmentation mask; means for processing the first portion of the image data using a first number of diffusion steps of a diffusion model to generate a partially-modified first portion of the image data; and means for processing the partially-modified first portion of the image data and the second portion of the image data using a second number of diffusion steps of the diffusion model to generate modified image data.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a vehicle (or a computing device, component, or system of a vehicle), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example implementation of a system, which may include a central processing unit (CPU), configured to perform one or more of the functions described herein;

FIG. 2 includes two sets of images that show the forward diffusion process (which is fixed) and the reverse diffusion process (which is learned) of a diffusion model;

FIG. 3 is a diagram illustrating how diffusion data is distributed from initial data to noise using a diffusion model in the forward diffusion direction, in accordance with some aspects of the present disclosure;

FIG. 4 is a diagram illustrating a U-Net architecture for a diffusion model, in accordance with some aspects of the present disclosure;

FIG. 5 is a block diagram illustrating an example latent diffusion model 500 that may implement steps of a latent diffusion process, according to various aspects of the present disclosure;

FIG. 6 includes two images to illustrate examples of modified image data or modified video data;

FIG. 7 includes two images to illustrate examples of modified image data or modified video data;

FIG. 8 includes a number of circles representative of tokens of an image;

FIG. 9A is a block diagram illustrating an example image/video modification system, according to various aspects of the present disclosure;

FIG. 9B is a block diagram illustrating an example image/video modification system, according to various aspects of the present disclosure;

FIG. 10 includes representations tokens of three frames, according to various aspects of the present disclosure;

FIG. 11 is an example of an image being processed through various steps of a diffusion process, according to various aspects of the present disclosure;

FIG. 12 is a block diagram illustrating an example system that may implement a diffusion-blending process, according to various aspects of the present disclosure;

FIG. 13 is a block diagram illustrating an example system that may implement a diffusion-blending process;

FIG. 14 is a flowchart illustrating an example of a process for modifying video data, according to various aspects of the present disclosure;

FIG. 15 is a flowchart illustrating an example of a process for modifying video data, according to various aspects of the present disclosure;

FIG. 16 is a flowchart illustrating an example of a process for modifying image data, according to various aspects of the present disclosure;

FIG. 17 is a flowchart illustrating an example of a process for modifying image data, according to various aspects of the present disclosure;

FIG. 18 is a flowchart illustrating an example of a process for modifying image data, according to various aspects of the present disclosure;

FIG. 19 is a block diagram illustrating an example of a deep learning neural network that can be used to implement a perception module and/or one or more validation modules, according to various aspects of the present disclosure;

FIG. 20 is a block diagram illustrating an example of a convolutional neural network (CNN), according to various aspects of the present disclosure; and

FIG. 21 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Diffusion-based video editing techniques have reached impressive quality and can transform an input video by, for example, replacing objects and attributes of-interest or synthesizing frames according to a desired style. However, such solutions typically require high computational costs to preserve temporal consistency in generated frames, such as in the form of diffusion inversion and/or cross-frame interaction within self-attention modules.

Systems and techniques are described herein that introduce several techniques to gain efficiency in modifying image data (e.g., video content, such as one or more frames of a video). According to some aspects, a machine learning model (e.g., a neural network model) can include a spatio-temporal token merging mechanism to fuse redundant tokens at inference of the machine learning model, which can increase the speed of spatio-temporal attention (e.g., in zero-shot techniques). Additionally or alternatively, in some cases, the machine learning model can include a saliency-based merging mechanism, which can provide a trade-off of the ratio of preserved tokens in foreground regions of a frame (e.g., a frame of video) and background regions of the frame, allowing adaptive resource allocation. In some examples, the computational cost of the machine learning model can be further reduced by completely avoiding diffusion processes on certain regions of frames (e.g., background regions of the frames), which may be unnecessary when editing other portions of the frames (e.g., foreground object shapes or attributes).

Various aspects of the application will be described with respect to the figures below.

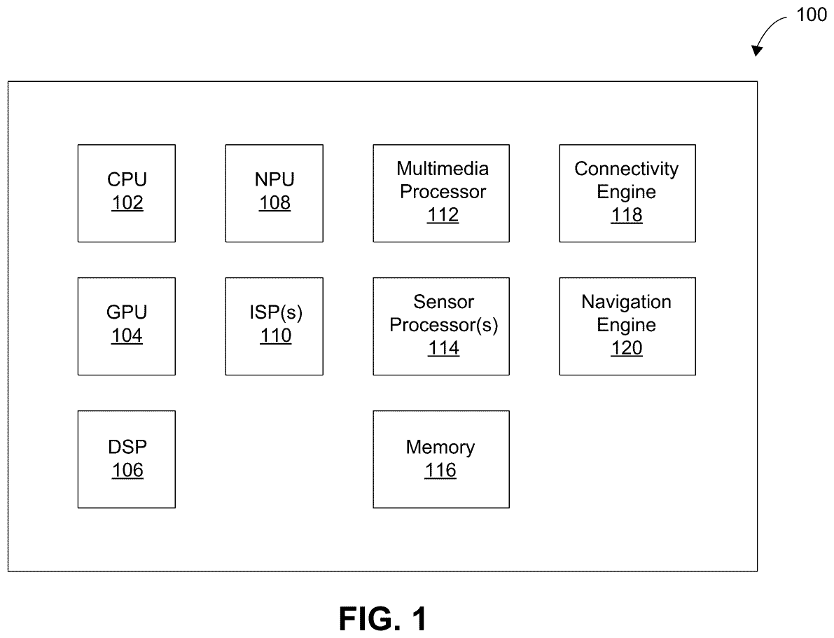

FIG. 1 illustrates an example implementation of a system 100, which may include a central processing unit (CPU 102) (which may be a multi-core CPU), configured to perform one or more of the functions described herein. Parameters or variables (e.g., neural signals and synaptic weights), system parameters associated with a computational device (e.g., neural network with weights), task information, among other information may be stored in a memory block associated with a neural processing unit (NPU 108), in a memory block associated with a CPU 102, in a memory block associated with a graphics processing unit (GPU 104), in a memory block associated with a digital signal processor (DSP 106), in a memory 116, and/or may be distributed across multiple blocks. Instructions executed at the CPU 102 may be loaded from a program memory associated with the CPU 102 or may be loaded from memory 116.

The system 100 may also include additional processing blocks tailored to specific functions, such as the GPU 104, the DSP 106, a connectivity engine 118, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, the DSP 106, and/or the GPU 104. The system 100 may also include one or more sensor processor(s) 114, one or more image signal processors (ISP(s) 110), and/or navigation engine 120, which may include a global positioning system. In some examples, the sensor processor(s) 114 can be associated with or connected to one or more sensors for providing sensor input(s) to the sensor processor(s) 114. For example, the one or more sensors and sensor processor(s) 114 can be provided in, coupled to, or otherwise associated with a same computing device.

The system 100 may be implemented as a system on a chip (SoC). The system 100 may be based on an Advanced Reduced Instruction Set Computer (RISC) Machine (ARM) instruction set. The system 100 and/or components thereof may be configured to perform machine learning techniques according to aspects of the present disclosure discussed herein. For example, the system 100 and/or components thereof may be configured to implement a machine-learning model (e.g., a quantized trained machine-learning model) as described herein and/or according to aspects of the present disclosure.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, diffusion-based neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

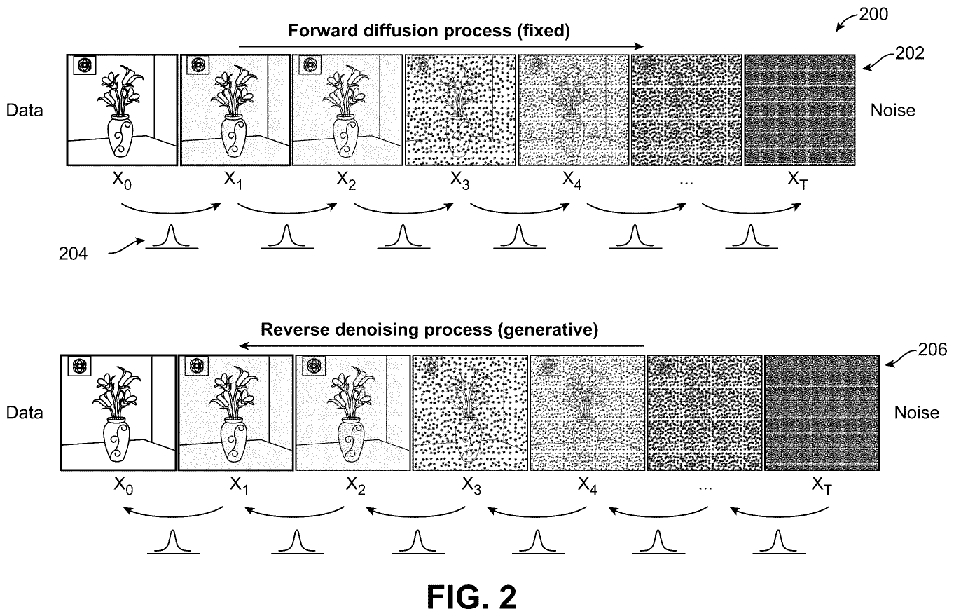

FIG. 2 provides two sets of images 200 that show the forward diffusion process (which is fixed) and the reverse diffusion process (which is learned) of a diffusion model. As shown in the forward diffusion process of FIG. 2, noise 204 is gradually added to a first set of images 202 at different time steps for a total of T time steps (e.g., making up a Markov chain), producing a sequence of noisy samples X₁ through X_{T}.

Diffusion models from a training perspective will take an image and will slowly add noise to the image to destroy the information in the image. In some aspects, the noise 204 is Gaussian noise. Each time step can correspond to each consecutive image of the first set of images 202 shown in FIG. 2. The initial image X₀ of FIG. 2 is of a cat. Addition of the noise 204 to each image (corresponding to noisy samples X₁ to X_{T}) results in gradual diffusion of the pixels in each image until the final image (corresponding to sample X_{T}) essentially matches the noise distribution. For example, by adding the noise, each data sample X₁ through X_{T} gradually loses its distinguishable features as the time step becomes larger, eventually resulting in the final sample X_{T} being equivalent to the target noise distribution, for instance a unit variance zero-Gaussian [symbol] (0,1).

The second set of images 206 shows the reverse diffusion process in which X_{T} is the starting point with a noisy image (e.g., one that has Gaussian noise). The diffusion model can be trained to reverse the diffusion process (e.g., by training a model p_{θ}(xₜ₋₁|xₜ)) to generate new data. In some aspects, a diffusion model can be trained by finding the reverse Markov transitions that maximize the likelihood of the training data. By traversing backwards along the chain of time steps, the diffusion model can generate the new data. For example, as shown in FIG. 2, the reverse diffusion process proceeds to generate X₀ as the image of the cat. In other cases, the input data and output data can vary based on the task for which the diffusion model is trained.

As noted above, the diffusion model is trained to be able to denoise or recover the original image X₀ in an incremental process as shown in the second set of images 206. In some aspects, the neural network of the diffusion model can be trained to recover Xₜ given Xₜ₋₁, such as provided in the below example equation:

$$q ( {x}_{t} \vert {x}_{t - 1} ) = 𝒩 ( {x}_{t} ; \sqrt{1 - {β}_{t}} {x}_{t - 1} , {β}_{t} I )$$

A diffusion kernel can be defined as:

$$Define {\hat{∝}}_{t} = {\prod }_{s = 1}^{t} ( 1 - {β}_{s} ) \to q ( {x}_{t} \vert {x}_{0} ) = 𝒩 ( {x}_{t} ; \sqrt{{\hat{∝}}_{t}} {x}_{0} , ( 1 - {\hat{∝}}_{t} ) I )$$

Sampling can be defined as follows:

$${x}_{t} = \sqrt{{\hat{∝}}_{t}} {x}_{0} + \sqrt{1 - {\hat{∝}}_{t}} ε where ε \sim 𝒩 ( 0 , I ) .$$

In some cases, the βₜ values schedule (also referred to as a noise schedule) is designed such that \hat{∝}_{T}→0 and q(x_{T}|x₀)≈ [symbol] (x_{T}; 0,I).

The diffusion model runs in an iterative manner to incrementally generate the input image X₀. In one example, the model may have twenty steps. However, in other examples, the number of steps can vary.

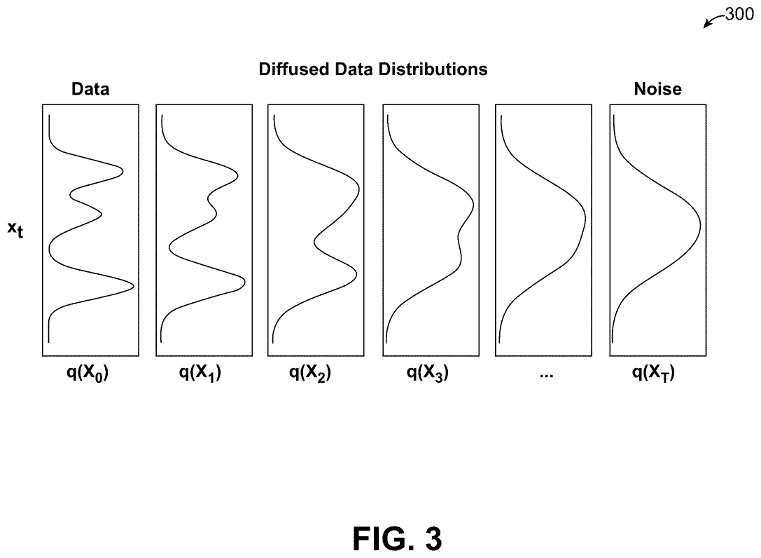

FIG. 3 is a diagram 300 illustrating how diffusion data is distributed from initial data to noise using a diffusion model in the forward diffusion direction, in accordance with some aspects. Note that the initial data q(X₀) is detailed in the initial stage of the diffusion process. An illustrative example of the data q(X₀) is the initial image of the flowers in a vase shown in FIG. 2. As the diffusion model iterates and iteratively adds sampled noise to the data from t=0 to t=T, as shown in FIG. 3, the data becomes nosier and may ultimately result in pure noise (e.g., at q(X_{T})). The example of FIG. 3 illustrates the progression of the data and how it becomes diffused with noise in the forward diffusion process.

In some aspects, the diffused data distribution (e.g., as shown in FIG. 3) can be as follows:

$$q ( {x}_{t} ) = \int q ( {x}_{0} , {x}_{t} ) {dx}_{0} = \int q ( {x}_{0} ) q ( {x}_{t} \vert {x}_{0} ) {dx}_{0} .$$

In the above equation, q(xₜ) represents the diffused data distribution, q(x₀, xₜ) represents the joint distribution, q(x₀) represents the input data distribution, and q(xₜ|x₀) is the diffusion kernel. In this regard, the model can sample xₜ˜q(xₜ) by first sampling x₀˜q(x₀) and then sampling xₜ˜q(xₜ|x₀) (which may be referred to as ancestral sampling). The diffusion kernel takes the input and returns a vector or other data structure as output.

The following is a summary of a training algorithm and a sampling algorithm for a diffusion model. A training algorithm can include the following steps:
1: repeat
2: x₀˜q(x₀)
3: t˜Uniform ({1, . . . , T})
4: ∈˜ [symbol] (0, I)
5: Take gradient descent step on

$${∇}_{∅} {‖ ∈ - {∈}_{∅} ( \sqrt{{\hat{∝}}_{t} {x}_{0}} + \sqrt{{1 - \hat{∝} )}_{t}} ∈ , t ) ‖}^{2}$$

6: until converged
   6:

A sampling algorithm can include the following steps:
1: x_{T}˜ [symbol] (0,I)
2: for t=T, . . . , 1 do
3: z˜ [symbol] (0,I)

$$4 : {x}_{t - 1} = \frac{1}{\sqrt{{\hat{∝}}_{t}}} ( {x}_{t} - \frac{1 - {\hat{∝}}_{t}}{\sqrt{1 - {\hat{∝}}_{t}}} {∈}_{∅} ( {x}_{t} , t ) ) + {σ}_{t} z$$

5: end for
6: return x₀

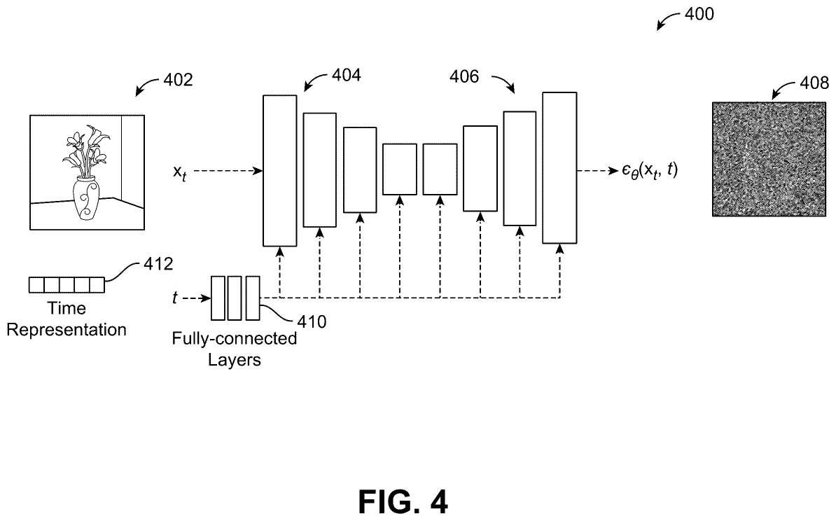

FIG. 4 is a diagram illustrating a U-Net architecture 400 for a diffusion model, in accordance with some aspects. The initial image 402 (e.g., flowers in a vase) is provided to the U-Net architecture 400 which includes a series of residual networks (ResNet) blocks and self-attention layers to represent the network ϵ_{θ} (xₜ, t). The U-Net architecture 400 also includes fully connected layers 410. In some cases, time representation 412 can be sinusoidal positional embeddings or random Fourier features. Noisy output 408 from the forward diffusion process is also shown.

The U-Net architecture 400 includes a contracting path 404 and an expansive path 406 as shown in FIG. 4, which gives it the U-shaped architecture. The contracting path 404 can be a convolutional network that includes repeated convolutional layers (that apply convolutional operations), each followed by a rectified linear unit (ReLU) and a max pooling operation. When images are being processed (e.g., the image 402) during the contracting path 404, the spatial information of the image 402 is reduced as features are generated. The expansive path 406 combines the features and spatial information through a sequence of up-convolutions and concatenations with high-resolution features from the contracting path 404. Some of the layers can be self-attention layers, which leverage global interactions between semantic features at the end of the encoder to explicitly model full contextual information.

Latent diffusion models (also referred to as stable diffusion models) introduce a diffusion process in the latent space of a machine learning model (e.g., variational autoencoder (VAE) neural network), making the machine learning model more efficient while enabling high-resolution image synthesis. For example, an Encoder (E)-Decoder (D) pair of a VAE can be trained to capture a low-dimensional latent distribution given by z=ε(x) such that x∞D(z). The denoising process outlined above can be formulated in this latent space by training a U-Net (e.g., U-Net architecture 400 of FIG. 4), which may include ResNet blocks and attention modules in some cases, to predict the noise introduced in the forward diffusion process, which optimizes the objective given by the following:

$${min}_{θ} {𝔼}_{z 0 , ϵ ∼ N ( 0 , 1 ) , t ∼ U ( 0 , τ )} {‖ ϵ - {ϵ}_{θ} ( {z}_{t} , t , c ) ‖}_{2}^{2}$$

Here, ϵ is the total noise introduced to the noise-free latent z₀˜E(x) by the scheduler in T steps, zₜ is the corresponding partially-noisy latent at diffusion timestep t, and c is conditioning (e.g., text prompt embedding provided as input). With the predicted noise ϵ_{θ}, denoising diffusion implicit models (DDIM) sampling can be applied on z_{T} over T steps iteratively to recover z₀ in the original latent data distribution, such as in the following:

$${z}_{t - 1} = \sqrt{{α}_{t - 1}} \frac{{z}_{t} - \sqrt{1 - {a}_{t} {ϵ}_{θ}}}{\sqrt{{α}_{t}}} + \sqrt{1 - {α}_{t} {ϵ}_{θ}} ,$$

where αₜ is a parameter for noise scheduler.

When adopting Stable Diffusion (SD) to video generation or video editing, a key factor is to ensure the temporal consistency of a generated frame relative to one or more previous frames in the video. In addition to modifications to the U-Net model (such as temporal attention and 2+1D convolutions), it helps to rely on control signals, and/or DDIM inversion to start the denoising with a correlated set of noise latents.

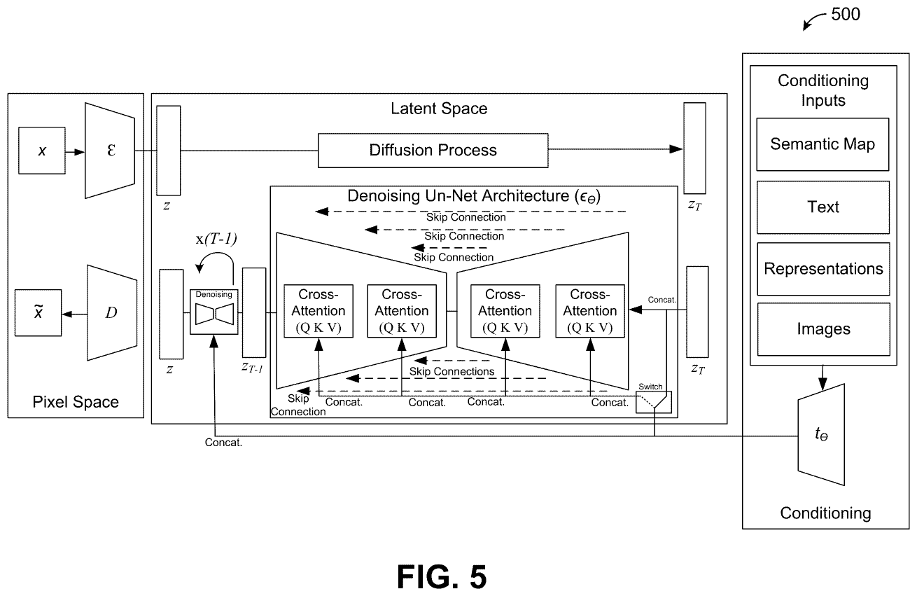

FIG. 5 is a block diagram illustrating an example latent diffusion model 500 that may implement steps of a latent diffusion process, according to various aspects of the present disclosure. Latent diffusion model 500 may modify video or image data. Latent diffusion model 500 may be an example of a video (or image) editing system. The principles described herein may be implemented in (and/or using) latent diffusion models such as that illustrated in FIG. 4, FIG. 5, and/or other diffusion models.

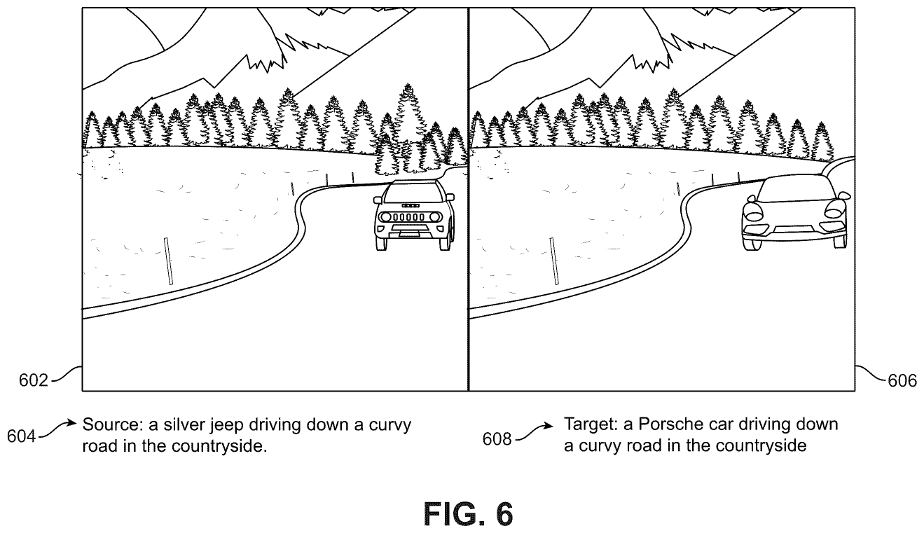

FIG. 6 includes two images to illustrate examples of modified image data or modified video data. For example, FIG. 6 includes an image 602 that may be a frame of video data. Image 602 may be provided as an input to an image-editing or video-editing system (e.g., latent diffusion model 500 of FIG. 5). FIG. 6 includes target prompt 608 that may be provided along with image 602 to the image-editing or video-editing system. FIG. 6 further includes image 606 that may be a frame of video data that may be an output of the image-editing or video-editing system. The image-editing or video-editing system may modify image 602 according to target prompt 608 to generate image 606. FIG. 6 illustrates an example of shape editing, where a shape of an object in image 602 is modified in image 606.

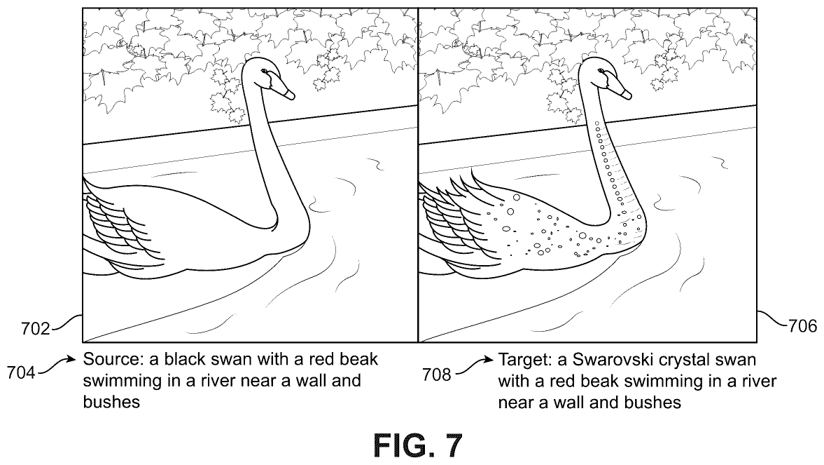

FIG. 7 includes two images to illustrate examples of modified image data or modified video data. For example, FIG. 7 includes an image 702 that may be a frame of video data. Image 702 may be provided as an input to an image-editing or video-editing system (e.g., latent diffusion model 500 of FIG. 5). FIG. 7 includes target prompt 708 that may be provided along with image 702 to the image-editing or video-editing system. FIG. 7 further includes image 706 that may be a frame of video data that may be an output of the image-editing or video-editing system. The image-editing or video-editing system may modify image 702 according to target prompt 708 to generate image 706. FIG. 7 illustrates an example of attribute editing, where an attribute of an object in image 702 is modified in image 706.

A video-editing system (e.g., latent diffusion model 500 of FIG. 5) may take as input a video (e.g., including image 602 or image 702) and/or one or more images and a target prompt (e.g., target prompt 608 or target prompt 708). The target prompt may describe how a user would want the output video or images to look. Shape editing is illustrated by FIG. 6 in which, in image 602 there is a Jeep that is driving. Target prompt 608 is for the Jeep to become a Porsche car. Attribute editing may preserve the shape of the object but rather change the style or add to one of the attributes of the object. For instance, FIG. 7 illustrates shape editing. In FIG. 7, target prompt 708 is for the swan in image 702 to become as Swarovski crystals swan with the red beak swimming in the river near walls and bushes.

Diffusion models have become commonly used as a generative artificial intelligence (AI)/machine learning (ML) solution for generating images and videos. Diffusion models for video editing work as follows. A latent diffusion model (LDM) may be pre-trained on data. The LDM can typically generate, given a text prompt, a single image. A stable diffusion model is an example of an LDM. Given an image model, the LDM may enforce the creation of frames that are temporarily consistent with each other so that they represent a video stream.

For example, a video may include a background and an object that moves coherently and naturally in frames of the video. Temporal consistency can be achieved on top of these latent diffusion models using a few techniques. One technique is called diffusion inversion. Another is called conditioning. Conditioning involves inputting other control signals that are temporarily correlated. Conditioning may look at all frames in order to create a next frame. Additionally or alternatively, cross-frame operations may be enabled to encourage temporal consistency. Enabling cross-frame operations may be applied with or without inversion and/or conditioning.

Video modifying techniques are computationally expensive. For example, editing images and/or video (e.g., to modify shapes or attributes of objects) may be computationally expensive. In the present disclosure, the term computationally expensive may refer to computing operations which may take time and/or consume power. It may take seconds to modify a single image. The computational expenses of video modification may prevent these types of models (e.g., LDMs) from modifying video data in real time.

Diffusion models operate a sequence of diffusion steps, for example, in a chain of diffusion steps (e.g., 20 to 50 applications of a unit model on a latent variable to the noise). The chain of diffusion steps may be computationally expensive. One of the reasons the diffusion steps are expensive is because the unit model is based on a self-attention operation and self-attention operations can be expensive computationally expensive. In other words, Latent Diffusion Models (LDMs) may run a denoising model iteratively, for example, between 20-50 diffusion steps. Every step may include computationally expensive self-attention operations.

In some cases, a machine learning model can output tokens based on processing a frame. In the present disclosure, the term token may refer to a feature vector of a specific portion of an input. In the context of video frames, a token can refer to a feature vector including values representing the visual characteristics of a portion or region of a video frame (e.g., a location within the video frame). When performing self-attention, tokens interact with other tokens (e.g., the self-attention operations process the values of the various tokens). A token in this context may be a pixel in a representation space of the unit. A token may represent a spatial location in latent space of the unit. As noted above, self-attention is an expensive operation. If there are redundant tokens for an image (e.g., tokens that look very similar to each other), the redundant tokens carry redundant information. Redundant tokens can be potentially removed from the self-attention operation, making self-attention more efficient.

Token merging is a technique that can be used to remove redundant tokens. For example, tokens that are similar can be merged into a single token as they carry redundant information. Tokens that are dissimilar to other tokens are left unmerged. Token merging can speed up LDMs by approximately 2 times (or more) by reducing the number of tokens.

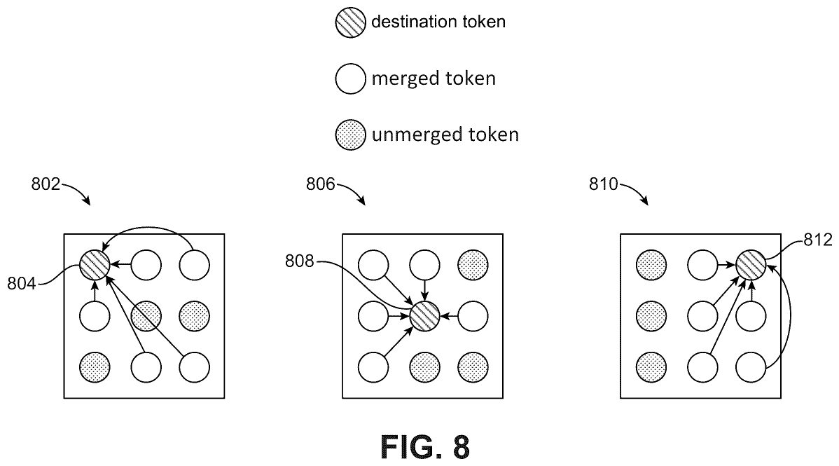

FIG. 8 includes a number of circles representative of tokens of three images (e.g., three successive frames of video data). In particular, FIG. 8 includes a representation of tokens of three image frames (frame 802, frame 806, and frame 810) with nine tokens per frame. Each of the tokens may be, or may include, a feature vector including feature values representing a corresponding location of a frame. The tokens are illustrated relative to respective locations of a particular frame. For instance, the token 804 may be a feature vector including feature values representing a top-left portion of a frame 802.

As noted above, token merging can be used to remove redundant tokens. For example, token merging may include identifying (e.g., by randomly sampling), for every frame, one or more destination tokens. In the example of FIG. 8, one destination token per frame is illustrated for simplicity, including token 804 for the frame 802, token 808 for the frame 806, and token 812 for the frame 810. In other examples more destination tokens may be identified. Destination tokens are going to be preserved (e.g., not removed in the token merging). Token merging may include measuring the distance of all other tokens to the destination token (e.g., determining a Cosine similarity between each token and the destination token). Tokens that are similar to the destination token (e.g., based on a similarity threshold) may be merged (e.g., by average pooling). So in the case illustrated by FIG. 8, for frame 802, there are five merged tokens that are similar to destination token 804. The merged tokens are merged into destination token 804 by average pooling. The merged tokens can then be removed. This leaves some tokens that are dissimilar to the destination tokens that are not going to be merged; they may be referred to as unmerged tokens. After this operation, destination tokens and unmerged tokens remain. The merged tokens are removed from further computations. In the example illustrated in FIG. 8, four tokens per frame are preserved. This speeds computations. Token merging thus conserves computational resources making image and/or video editing using LDMs less computationally expensive.

Token merging may be applied at one or more (e.g., each) of the self-attention modules of an LDM. For example, an LDM may include a U-Net architecture with an encoder and a decoder (e.g., as illustrated in latent diffusion model 500 of FIG. 5). There may be self-attention modules applied throughout the encoder and the decoder. Token merging may be applied in one or more of the self-attention modules. For example, each unit block of an LDM may include a self-attention module, a cross-attention module, and some residual convolutions. Token merging may be applied before each self-attention module for every layer for all the diffusion steps.

When applying stable diffusion to videos, a self-attention module may apply self-attention to the tokens within each frame. The self-attention module may function in a similar manner as a cross-frame attention module (e.g., a module that applies cross attention across multiple frames), such as when the query tokens come from one frame, but keys and values come from another frame. This is different from performing cross attention to text tokens (e.g., of the text prompts). The cross-frame attention nature of the self-attention modules is not depicted in the figures. Additionally or alternatively, token merging may be applied when performing cross attention across frames.

An LDM may use the tokens by projecting the tokens with linear projections. In some cases, there may be a layer (of an LDM) that takes a token and outputs queries, keys, and values for every token. The LDM may use as many queries as there are tokens, as many keys as there are tokens, and as many values as there are tokens. For example, the tokens may be projected, and for every input token, there can be one query, one key, and one value. In such an example, the cost of computing self-attention is quadratic in the number of tokens.

Token Merging (ToMe) may be implemented as a zero-shot plugin for Visual Transformers (ViTs) to reduce the computational requirement by removing redundant tokens. In contrast to token pruning methods, ToMe introduces a lightweight merging mechanism based on token similarities. For example, a pre-defined percentage of tokens with the highest cosine similarity to any of the other tokens are piggybacked together to save computations (and, improve throughput). ToMe can be used for text-to-image generation based on stable diffusion, along with techniques such as token unmerging and grid-based token sampling.

For example, a latent token representation x∈ [symbol] ^{B×T×N×C} can be provided, where B, represents a batch, T represents a number of frames, N represents a number of tokens, and C represents a number of channels, respectively. The number of tokens N can be further expressed as H×W, representing height (e.g., a number of pixels in a vertical direction) and width (e.g., a number of pixels in a horizontal direction). To compute similarities among tokens, the tokens can be split into two sets, including destination (x^{dst}) and source tokens (x^{src}). The destination tokens in x^{dst} can be sampled to be uniformly distributed across each frame, such as by choosing sampling indices based on a two-dimensional (2D) grid of size (sₕ×s_{w}),

$${idx}_{t , h , w}^{dst} = ( t , h \cdot {s}_{h} + rand ( {s}_{h} ) , w \cdot {s}_{w} + rand ( {s}_{w} ) ) , \qquad ( Eq . 1 )$$

parameterized by integers t∈[0, T), h∈[0, H/sₕ) and w∈[0, W/s_{w}. Here, rand(.) is a pseudorandom integer generator, parameterized by an upper bound. The rest of the tokens are grouped per-frame to formx^{src}=[xₜ^{src}|t∈[0, T)].

Next, similarities between source tokens x^{src} and destination tokens x^{dst} can be computed per-frame, such as follows:

$${Sim}_{{x}^{{src}_{, x} dst}} = [ cos ( {x}_{t}^{src} , {x}_{t}^{dst} ) \vert t ∈ [ 0 , T ) ] , \qquad ( Eq . 2 )$$

where cos(.) represents the cosine similarity between two collections of vectors. Finally, r % of source tokens with highest similarities with any destination token within the frame are merged (via average pooling), essentially combining the most-redundant source tokens with the corresponding destination matches. Such merged tokens are denoted by x^{mer} and the unmerged tokens by x^{unm}. What remains after the merging operation is the set of [x^{dst}, x^{unm}]. ToMe is usually applied prior to an attention block, where the compute savings can be maximized. It can either be applied to key-value pairs only, or all query-key-value triplets. In both cases, the indices computed in Eq. 1 should be shared between key-value pairs. When applying ToMe on the triplets, the output representation should be unmerged after the attention operation to preserve the original shape (or, resolution) especially for generative tasks. This is done by Token Unmerging, which simply copies merged tokens to their original locations based on the same set of indices.

The systems and techniques described herein can perform three-dimensional (3D) token merging. In some cases, the 3D token merging provides a token reduction technique for images and/or videos that may be implemented on-top of Token Merging (ToMe), in which case the 3D token merging can be referred to herein as 3D ToMe. ToMe may be implemented for Visual Transformers (ViTs) in the image domain. A naive extension would be to apply ToMe separately for each frame. There are at least two limitations to this approach: (1) not taking temporal redundancy into account, and (2) not maximizing the information preserved after merging. In the case of video inputs, redundant information is present in the temporal axis (e.g., from frame-to-frame across time), such as in common frame rates (e.g., 25-30 frames per second (fps)). If ToMe is applied on each frame separately, it will still preserve some tokens every frame, which might not be required. But rather, if some temporal tokens can be dropped (e.g., tokens having same information across time), the potential results include higher reduction rates (and, better latency). Moreover, the destination token indices sampled for ToMe need not be the same for every frame. The 3D token merging techniques described herein can preserve different pieces of information if different randomization is used for every frame (see Eq. 1). The above-noted limitations of ToMe are addressed by 3D ToMe. First, according to the 3D ToMe technique, a system can define a spatio-temporal grid for sampling destination tokens (x^{dst}) having a size of (sₜ×sₕ×s_{w}) as in,

$${idx}_{t , h , w}^{d s t} = ( t \cdot {s}_{t} + rand ( {s}_{t} ) , h \cdot {s}_{h} + rand ( {s}_{h} ) , w \cdot {s}_{w} + rand ( {s}_{w} ) ) \qquad ( Eq . 3 )$$

parameterized by integers t∈[0, T/sₜ), h∈[0, H/sₕ), w∈[0, W/s_{w}). This allows the system to reduce the number of tokens preserved as x^{dst}, in which case the system can sample per each temporal window sₜ instead of every frame. By controlling the temporal window sₜ∈[0, T], there can be trade-offs in the temporal redundancy. The rest of the tokens are considered as x^{src}. The system can utilize two options to compute similarities between source and destination, including: (1) Windowed Temporal Search (WTS), in which similarities are computed among tokens within each temporal window sₜ separately, or (2) Global Temporal Search (GTS), in which similarities are computed among all tokens across all frames at once.

With respect to the windowed temporal search, each source can only be matched into a destination within the same temporal window, giving more control over temporal merging based on, for example, the following:

$${sim}_{{x}^{src} , {x}^{dst}} = [ cos ( {x}_{t}^{src} , {x}_{t}^{dst} ) \vert t ∈ [ 0 , T / {s}_{t} ) ] . \qquad ( Eq . 4 )$$

For the global temporal search, each source can be matched into any destination within the whole spatio-temporal volume, such as based on the following:

$${sim}_{{x}^{{src}_{, x} dst}} = [ cos {x}^{src} , {x}^{dst} ] . \qquad ( Eq . 5 )$$

In some cases, to maximize the information preserved across frames, different randomized indices can be computed to sample destination tokens per each temporal window. Similar to 2D ToMe, if 3D ToMe is applied on query-key-value triplets, the same unmerging operation can be performed after the attention layer.

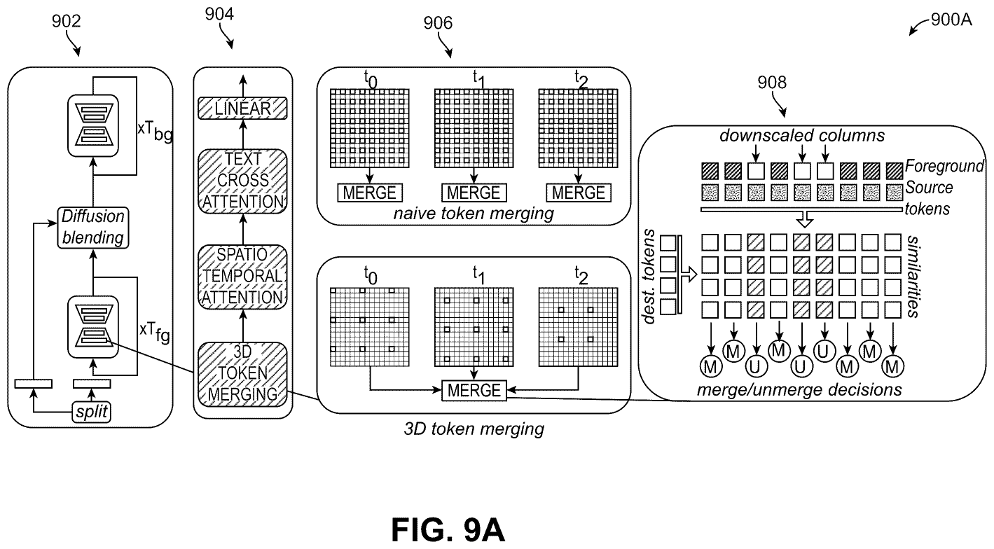

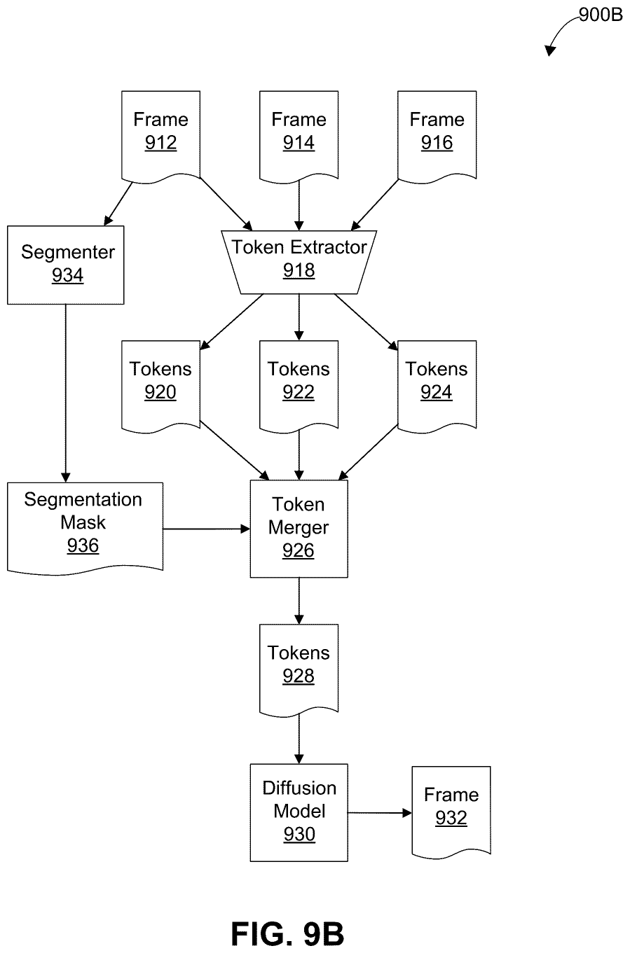

FIG. 9A is a block diagram illustrating an example image/video modification system (e.g., system 900A) (e.g., a latent diffusion model (LDM)) on the left. FIG. 9A further includes an expanded view of an example one of the layers of an encoder of the LDM including a 3D token merging module. FIG. 9A further includes a view of operation of the 3D token merging module on tokens of three example frames.

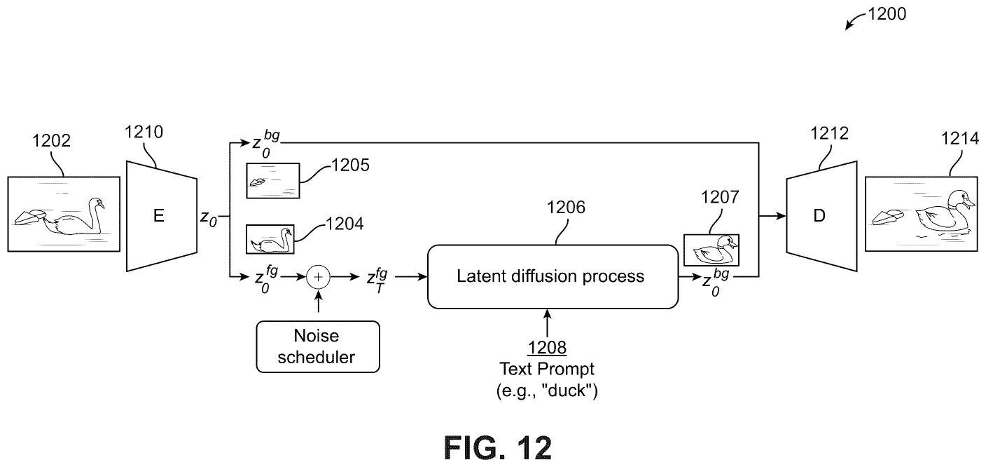

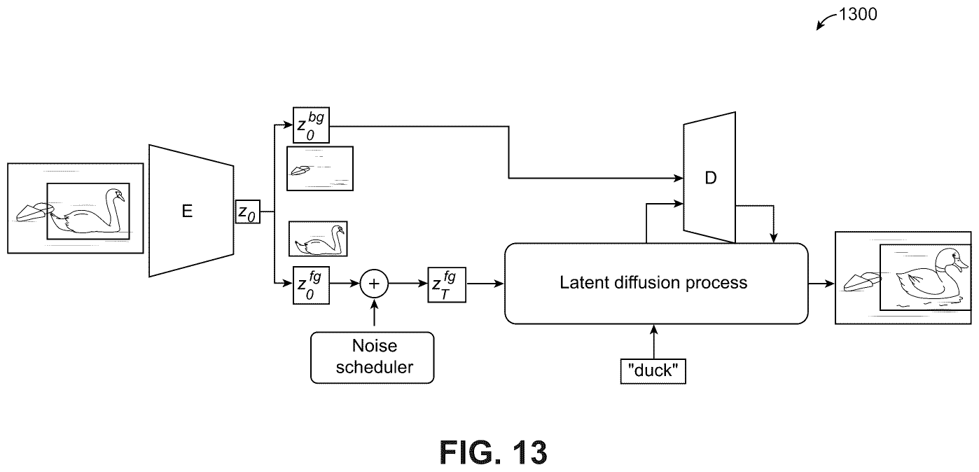

The leftmost column of FIG. 9A, column 902, illustrates foreground-only diffusion, where part of the latent (the foreground) undergoes all the diffusion steps and part of the latent (the background) skips the first T_fg steps. Additional detail regarding causing part of the latent to skip at least some diffusions steps is provided with regards to FIG. 12 and FIG. 13.

The second-from-the-left column of FIG. 9A, column 904, illustrates a typical configuration of one layer within a Unet of the leftmost column. The second-from-the-left column, column 904, illustrates where 3D token merging is applied (e.g., before spatio-temporal attention).

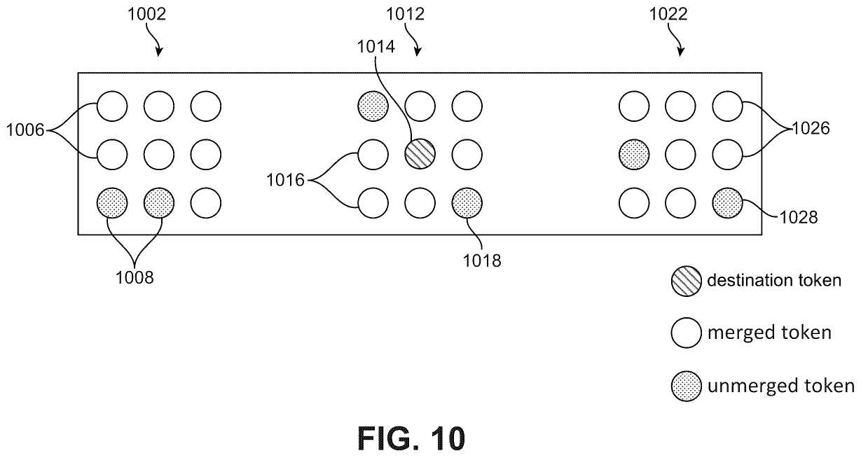

The third-from-the-left column of FIG. 9A, column 906, illustrates the difference between the original token merging (on top) and the 3D token merging (in the bottom). There are fewer destination tokens in the 3D token merging example. Further tokens are merged across frames, which conserves computational resources. Additional detail regarding token merging is provided with regard to FIG. 10.

The rightmost column of FIG. 9A, column 908 illustrates saliency-based token merging. For example, when computing Cosine similarity between tokens, foreground/background information (e.g., a segmentation map) is used to artificially downweight the similarities of foreground tokens, decreasing the probability of them to be merged into destination tokens. This helps preserve quality in foreground regions.

FIG. 10 includes representations tokens of three frames, a frame 1002, a frame 1012, and a frame 1022. According to 3D token merging, one destination token (e.g., token 1014) is selected for all three of the frames. Then, merged tokens (e.g., tokens 1006, tokens 10016, and tokens 1026) are identified in all three of the frames (e.g., based on a Cosine similarity between tokens of all three of the frames and the one destination token). In the example illustrated in FIG. 10, there are two unmerged tokens per frame. This illustrates a significant reduction in token number which results in a significant conservation of computational resources.

3D token merging may exploit temporal redundancy. Further, 3D token merging may allow flexibility to trade-off spatial reduction and temporal reduction for the same cost. 3D token merging may allow for more correlated tokens in a bigger pool (e.g., the pool including tokens from multiple frames). Further 3D token merging may enable long-term temporal attention, which may be not feasible otherwise.

3D token merging may involve tokens from different frames interacting with each other in the merging phase. In FIG. 10, all the tokens from the three different frames are put in the same pool out of which a single destination token is sampled. In this pool similarities are determined and token merging is performed. 3D token merging exploits the temporal redundancy between frames. 3D token merging also uses a bigger pool of tokens to potentially find correlated tokens to the destination tokens. This allows a higher chance to finding merged tokens that are similar to the destination token. By doing this, 3D token merging enables the operation of models that rely on temporal attention with a reasonable latency. Without 3D token merging, such models would be too slow for many applications. 3D token merging may apply to self-attention modules such that the self-attention modules are not isolated through frames.

There are a number of ways to select frames to which to apply 3D token merging. As another example, a pool of any number of frames of video data (e.g., 8 frames or 16 frames) may be selected. Following 3D token merging of the pool, a subsequent pool of frames may be selected and 3D merged. As another example, frames may be 3D merged in a sliding window. As another example, all the frames of video data may be 3D merged at the same time.

FIG. 9B is a block diagram illustrating an example system 900B that may perform 3D token merging, according to various aspects of the present disclosure. For example, system 900B may obtain a frame 912, a frame 914, and a frame 916. Frame 912, frame 914, and frame 916 may be frames (e.g., successive frames) of video data.

A token extractor 918 of system 900B may generate tokens 920 based on frame 912, tokens 922 based on frame 914, and tokens 924 based on frame 916. Each of tokens 920, tokens 922, and tokens 924 may be, or may include, a plurality of tokens. Each of the tokens may be, or may include, a feature vector corresponding to a respective location within a corresponding frame.

Token merger 926 of system 900B may determine a destination token from among tokens of one of frame 912, frame 914 or frame 916. For example, token merger 926 may determine a destination token from among tokens 922. In some aspects, token merger 926 may randomly select the destination token.

Further, token merger 926 may determine candidate tokens from among tokens 920, tokens 922, and tokens 924. In some aspects, token merger 926 may determine the candidate tokens based on a relationship between the candidate tokens and the destination token. For example, token merger 926 may determine the candidate tokens based on a Cosine distance between the candidate tokens and the destination token.

Further still, token merger 926 may merge the candidate tokens with the destination token. Token merger 926 may generate tokens 928. Tokens 928 may include the modified tokens. Tokens 928 may include tokens based on each of frame 912, frame 914, and frame 916.

Tokens 928 may provide tokens 928 to diffusion model 930 and diffusion model 930 may generate a frame 932 based on tokens 928. Frame 932 may include multiple frames. Diffusion model 930 may be an example the diffusion model in column 902 of FIG. 9A.

System 900B may obtain a group of frames (e.g., of video data); the group of frames including frame 912, frame 914, and frame 916. In some aspects, system 900B may select the group of frames from frames of the video data. In some aspects, following the generation of frame 932 based on the group of frames, system 900B may select another group of frames of the frames of the video data and process the other group of frames to generate another frame based on the other group of frames.

In some aspects, the group of frames may be a pool of frames including frame 912, frame 914, and frame 916. For example, system 900B may divide the frames of the video data into pools and process the frames of a given pools one at a time. In such cases, following the processing of the pool of frames including frame 912, frame 914, and frame 916, system 900B may process another pool of frames including three additional frames, for example, frames subsequent to frame 916 in the video data.

In some aspects, the group may be a sliding window of frames. For example, following the processing of the window of frames including frame 912, frame 914, and frame 916, system 900B may process a window of frames including frame 914, frame 916, and an additional frame (e.g., a frame subsequent to frame 916).

Additionally or alternatively, system 900B may implement saliency-based merging. For example, whether system 900B processed multiple frames (e.g., frame 912, frame 914, and frame 916) together (e.g., according to 3D token merging) or not, system 900B may implement saliency-based token merging by merging at least tokens 920 based on segmentation mask 936.

In some aspects, system 900B may include a segmenter 934 that may generate segmentation mask 936 based on one or more of frame 912, frame 914, and/or frame 916. Alternatively, system 900B may obtain Segmentation mask 936 from another source (e.g., a segmenter external to system 900B). Segmentation mask 936 may be, or may include, a foreground-background segmentation, a saliency segmentation, and/or a cross-attention map from latent representations.

In any case, token merger 926 may merge tokens based on segmentation mask 936. In the case in which system 900B implements 3D token merging and saliency-based token merging, token merger 926 may merge tokens 920, tokens 922, and tokens 924 based on segmentation mask 936. In any case, token merger 926 may merge tokens based on segmentation mask 936. In the case in which system 900B implements saliency-based token merging and not 3D token merging and, token merger 926 may merge tokens 920, based on segmentation mask 936.

To merge tokens (e.g., tokens 920, tokens 922, and/or tokens 924) based on segmentation mask 936, token merger 926 may weight respective relationships between the candidate tokens and the destination token based on corresponding portions of the segmentation mask. The weighting may cause tokens corresponding to salient portions of the image data, as identified by the segmentation mask, to be less likely to be determined to be candidate tokens.

Additionally or alternatively, the candidate tokens may be determined based on a relationship between a destination token and candidate tokens. The relationship may be determined as a Cosine similarity. The candidate tokens may be determined based on a similarity threshold. For example, the candidate tokens may be determined based on the relationship between the candidate tokens and the destination token satisfying the similarity threshold.

According to some aspects, the systems and techniques described herein can perform saliency-based token merging. For example, in generative modeling, the users often focus more on salient regions of the generated image/video. It may be a single or multiple foreground objects in a given input. Especially for video editing, the usual inputs include a prominent foreground, for which any inconsistencies (e.g., flickering) in the edited output get highlighted when viewing. Saliency-based Token Merging may include allocating more compute-budget on salient regions to preserve better quality in such regions, while also not having to sacrifice the quality of other regions.

Saliency-based token merging may be implemented with Token Merging (ToMe). ToMe may include sampling a subset of most-informative tokens. Saliency-based Token Merging may include forcing a higher percentage of such tokens to originate from salient regions within the same framework.

As introduced earlier, which tokens get merged is based on the computed similarities between source and destination tokens. Saliency-based Token Merging may downplay the similarities of source tokens corresponding to salient regions. This is done based on a saliency mask. A saliency mask can be, for example, acquired as or in oracle segmentation maps, defined in the dataset itself, included in segmentation maps extracted by an off-the-shelf model (e.g., a foreground-background segmentation mask or a saliency-based segmentation mask), and/or cross-attention maps within the latent representations of the U-Net itself (corresponding to specific keywords).

Based on a pre-defined (yet controllable) saliency strength (η), Saliency-based Token Merging may re-weight such similarities, forcing the corresponding source tokens to not merge. Given a binary saliency mask M∈ [symbol] ^{B×T×N×1}, the binary saliency mask is re-sample with source token indices M^{src}∈ [symbol] ^{B×T/s}^{ₜ}^{×N}^{_{src}}^{×1} which is then used to compute salient-similarities (SSim) as in,

$$SSim = η \cdot Sim \cdot {M}^{src} + Sim \cdot ( 1 - {M}^{src} ) , \qquad ( Eq . 6 )$$

where η∈[0,1] is the saliency strength. Here, the inputs to similarity computation are omitted for brevity. The merging operation is unchanged, which is now based on updated similarities SSim. A lower η corresponds to a higher number of tokens sampled from salient region. It is worth noting that the saliency applies only to x^{unm} among the preserved tokens, whereas x^{dst} is still being sampled based on the 3D grid. It means that some tokens will be sampled from non-salient regions (e.g., background), enabling reasonable quality in overall generation.

For example, in video editing, there may be a well-defined foreground. In many cases, only the foreground needs to be changed (e.g., through shape or attribute editing). Many image/video-editing applications generate segmentation masks internally (e.g., Oracle segmentation masks, cross-attention maps from latent representations). Saliency-based Token Merging encourages merging to happen on background tokens. Merging tokens in background regions may save a lot of computational resources in areas (of images or frames) in which the user will likely not be interested. Saliency-based Token Merging may artificially reduce the similarity of foreground tokens, forcing them to stay unmerged. This may result in adaptive resource allocation (e.g., more computation spent on salient foreground regions).

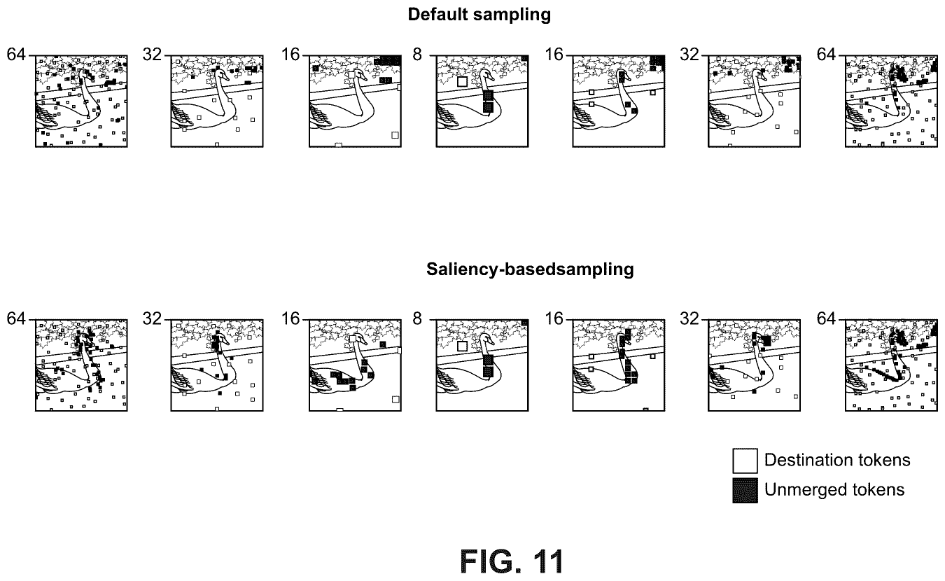

FIG. 11 is an example of an image being processed through various steps of a diffusion process. Illustrated in FIG. 11 are destination tokens and unmerged tokens. The default sampling illustrates destination tokens and unmerged tokens scattered across the image, including in the foreground and background. The saliency-based sampling illustrates that, based on Saliency-based Token Merging, many unmerged tokens are located on the foreground object and few merged tokens are on the foreground object. The token merging in the background may degrade the image quality in the background. The lack of merged tokens on the foreground object may cause the foreground object to retain its image quality.

There are the same number of destination and unmerged tokens between the default sampling example and the saliency-based sampling example. Token merging in both cases will thus have the same cost because total number of tokens is unchanged. However, token merging may degrade the image quality on the reconstruction of the background in the case of saliency-based sampling whereas the degradation of image quality may be in the background and the foreground in the default sampling case.

Saliency-based Token Merging may encourage merging to happen in the background. Saliency-based Token Merging may encourage unmerged tokens to be placed on foreground regions. For example, Saliency-based Token Merging may cause the unmerged tokens to be in the foreground regions. The unmerged tokens will simply be kept as they are, there is not going to be any merging happening on them. The unmerged tokens are going to be safely propagated to the layer and to self-attention. Whereas the destination tokens and the merged tokens may be subject to token merging which may affect a quality of the output image and/or video data.

Many video editing methods have a segmentation mask available internally that can be simply reused for Saliency-based Token Merging. Saliency-based Token Merging may weight similarities when the similarities of all tokens with respect to the destination tokens are computed. For example, similarities between each of the tokens and the destination token may be determined. Saliency-based Token Merging may determine whether a token that is being assessed is on the foreground. For foreground tokens, the similarity may be downscaled by a scaling factor. And that automatically will discourage those tokens from being merged.

According to some aspects, the systems and techniques described herein can perform diffusion blending. In some cases, cross-frame attention (either sparse or dense) layers can be the slowest component in a neural network model. However, after applying 3D ToMe with large reduction rates, the Residual Network (ResNet) blocks emerge as the new bottleneck, being more than 2× slower than attention blocks. In an all-transformer-based diffusion pipeline, there could have been more reductions with the same framework. However, since convolutions rely on the spatial structure (which is shuffled after ToMe), a different strategy may be needed to make the inference even faster.

For shape/attribute editing settings, which focus on making local changes to input frames (usually, on a foreground object) in contrast to style editing focused on global changes. For example, if all the latents-of-no-interest (e.g., background) are masked-out, the edited output of regions-of-interest (RoI) is surprisingly good. This means that in such settings, the diffusion pipeline does not need to rely on the context information at all. Processing only the regions-of-interest will result in further computational resource savings. To put this into practice diffusion blending uses two components: (1) sampling RoIs while being compatible with both attention and convolution layers, and (2) blending RoIs with non-RoIs generating consistent outputs.

With respect to sampling RoIs, it may be compute-efficient to sample an RoI by selecting latents corresponding to an RoI mask (e.g., a saliency mask, a segmentation mask, etc.), which can be irregularly-shaped. At the same time, the 3D spatio-temporal structure should be preserved after sampling, so that the output is compatible with convolutions. There exist variants of convolutions (e.g., deformable, sparse, and partial) that support irregular shapes; however such implementations are not as optimized (nor, fast) as convolutions with regular shapes. Further, for shape editing, if just the RoI is sampled and outputs generated, there can possibly be non-overlapping regions between the source RoI and the target. This may become a problem later-on when non-RoI regions are replaced and blended. Therefore, a simpler sampling strategy is used—cropping a regular bounding box around the RoI as the input. In practice this works well and gives reasonable speed-ups compared to more compute-efficient strategies and makes blending more convenient.

In some cases, the systems and techniques can blend an RoI with a non-RoI. For instance, when feeding only the RoI through the U-Net editing pipeline, the non-RoI region can be replaced at the output to get the desired reconstruction. A naïve option would be to just paste the generated RoI in-place, in the original frame. This can be done either in the latent space or pixel space, among which the former allows more flexibility. However, there are two problems with the naïve option: (1) the denoising process of the U-Net usually introduces global color shifts compared to the original input (even for shape/attribute editing for which this is particularly not desired), and (2) the boundary between RoI and non-RoI becomes prominent. When pasting in latent space (prior to VAE decoding), these problems can be avoided (1) by normalizing the RoI using the distribution statistics (mean and standard deviation) between the U-Net output (x_{UNet}^{RoI}) VAE encoder output (x_{VAE}^{RoI}) of the RoI region. Since the generated shape within the RoI may have statistics that may be undesirable to consider (e.g., color changes for swan→duck), it may be desirable to mask out the source and target object using the saliency mask M^{src} when computing {μ_{UNet}, σ_{UNet}, μ_{VAE}, σ_{VAE}} for the RoI. Note that these statistics are aggregated only across space (not over batch, time and channels). The normalization may be performed to update the U-Net output x_{UNet}^{RoI} before pasting it on the VAE encoder latents x_{VAE} as in,

$${x}_{UNet}^{RoI} = \frac{( {x}_{UNet}^{RoI} - {μ}_{UNet} )}{{σ}_{UNet}} \cdot {σ}_{VAE} + {μ}_{VAE} , \qquad ( Eq . 7 )$$

$${x}_{VAE} = p a d ( {x}_{UNet}^{RoI} ) \cdot {M}_{dil}^{srs} + {x}_{VAE} \cdot ( 1 - {M}_{dil}^{src} ) , \qquad ( Eq . 8 )$$

where pad (.) a padding operation so that RoI fits in-place in the original frame, and MIC is a dialated version of the saliency mask so that the boundary between RoI and non-RoI becomes smoother—which fixes the above problem (2) to some extent. A blending operation can also be performed in pixel space (e.g., Poisson Blending) to further address problem (2).

The systems and techniques can perform diffusion blending in some cases. For example, improving on the above operation, diffusion blending may be applied to perform blending in an intermediate diffusion step (rather than after all T diffusion steps). Here, denoising for (T−t̅) steps may be performed on the RoI to obtain z_{t̅}^{RoI}. Next, the results may be normalized, pasted, and blended in-place in a similarly-noised full-crop \tilde{z}_{t̅} (i.e, RoI+non-RoI) latent as described above. Then the rest of the t diffusion steps may be performed on the resulting full-crop. Such \tilde{z}_{t̅} can be acquired with Denoising Diffusion Implicit Models (DDIM) Inversion in an Inversion-based editing pipeline without significant extra cost. Diffusion be-lending can be represented as in,

$${z}_{\overline{t}} = pad ( {z}_{\overline{t}}^{RoI} ) \cdot {M}_{dil}^{src} + {\tilde{z}}_{\overline{t}} \cdot ( 1 - {M}_{dil}^{src} ) \qquad ( Eq . 9 )$$

This technique allows the non-RoI latents to only go-through only t̅ diffusion steps instead of T, creating a more-faithful non-RoI reconstruction in the generated edit sequence, while also saving compute (and, latency) spent on the same.

For shape and/or attribute editing, there may be no need to process background at all. Additionally or alternatively, there may be no loss of foreground reconstruction fidelity due to lack of background context. Therefore, diffusion blending may include feeding only foreground latents to the diffusion process. The result may be fewer tokens to run LDMs on, which may result in in higher inference speeds.

For example, in a latent diffusion model, in an encoder, there may be a latent space, where a latent diffusion process happens. The diffusion process may be, or may include, an iterative application of a U-Net that happens for 20 to 50 steps. The resulting latent may be refined. The refined latent may be decoded to generate the image. According to diffusion blending, the expensive latent diffusion process may be skipped for background portions of the image and applied to foreground portions of images. Thus, foreground portions may be modified by the latent diffusion process while background portions may remain unmodified.

Diffusion blending may use a segmentation mask (for example, the same segmentation mask used for saliency-based token merging). The segmentation mask might come from a cross attention module or an off-the-shelf saliency model. The latent of the image may be split (e.g., based on the segmentation mask into salient and non-salient portions). The image may be cropped to generate a rectangular portion of the image including the salient portion of the image (e.g., a foreground object). The cropped portion of the image may undergo the latent diffusion process. The cropped portion may be modified to generate an updated foreground latent based on the input image and the text prompt. The background portion of the image may bypass the latent diffusion process. The modified cropped portion and the background portion may then be recombined before decoding. Diffusion blending may reduce the cost of diffusion, because the diffusion is going to operate on a much smaller image that does not include the background.

For example, FIG. 12 is a block diagram illustrating a system 1200 that may implement a diffusion-blending process, according to various aspects of the present disclosure. For example, an encoder 1210 can extract features (z₀) (e.g., a latent representation or “latent”) from the input image 1202. The encoder 1210 may be a neural network encoder (e.g., a backbone neural network) trained to extract features from images. The system 1200 may crop (e.g., using an encoder 1210) a rectangular foreground portion 1204 from the image 1202. For example, the system 1200 can crop a portion of the features z0 corresponding to the foreground portion, denoted as z_{z0}^{fg}. In some examples, the portion 1204 may be selected based on the portion 1204 relating to a region of interest (e.g., based on a text prompt, not shown, indicating a swan as a region of interest). Additionally or alternatively, the portion may be selected based on a segmentation mask, such as a foreground-background segmentation mask. System 1200 may process the cropped portion 1204 using a latent diffusion process 1206. For example, the latent diffusion process 1206 may receive a text prompt 1208 and may transform an object in the cropped portion 1204 (e.g., a foreground object such as a swan) into a duck based on the prompt, resulting in a modified cropped portion 1207. A decoder 1212 of the system 1200 may then combine the modified cropped portion 1207 with the remainder 1205 of the image portion (e.g., the background), denoted as z_{z0}^{bg}, to generate output image 1214.

Alternatively, the portion 1204 and the remainder 1205 may not be blended after the whole diffusion process 1206, but somewhere in the diffusion process 1206. For example, the latent of the remainder 1205 may enter the latent diffusion process 1206 for some steps of the diffusion process (e.g., the final steps or stages). In such an example, instead of the latent of the remainder 1205 undergoing all diffusion steps of the latent diffusion process 1206 (e.g., 20 diffusion steps), the remainder 1205 latent may undergo only a final number of diffusion steps (e.g., the last or final five diffusion steps). For instance, if a latent diffusion process has 20 diffusion steps, 15 diffusion steps will be performed on the latents of the selected portion 1204. The reminder 1205 of the image may be injected and the last five diffusion steps will be performed on the latents of the whole images. In this way, the re-blending may be performed in the middle of the diffusion process.

For example, FIG. 13 is a block diagram illustrating a system 1300 that may implement a diffusion-blending process, according to various aspects of the present disclosure. For example, a rectangular portion may be cropped from an image. The portion may undergo a several diffusion steps of a latent diffusion process. The latent diffusion process may receive a text prompt and transforms the portion (e.g., a foreground object such as a swan) into a duck based on the prompt. After the portion has undergone a number of diffusion steps, the modified portion may be combined with a remainder of the image. The combined image may then undergo further diffusion steps of the diffusion process.

The techniques described herein (in particular 3D token merging, saliency-based token merging, and diffusion blending) may operate individually and/or together. For example, multiple frames of video data may be modified by a diffusion process using 3D token merging to merge tokens across frames. Merging tokens across frames may conserve computational resources.

Further, prior to performing the diffusion process, a foreground portion of each image may be identified (e.g., based on a saliency segmentation mask). The foreground portion may be a rectangle cropped from the image. The foreground portion may be processed by the diffusion process and the background process may forego at least some of the diffusion steps of the diffusion processing. Processing the foreground portion and foregoing at least some of the diffusion steps of the diffusion process is an example of diffusion blending. Skipping processing of portions of images may conserve computational resources.

Further, as tokens are merged (e.g., within a cropped portion of an image, within a full image frame, across multiple frames, and/or across multiple cropped portions of multiple respective images), the weights may be altered based on a segmentation map (e.g., according to saliency-based token merging). Modifying the weights based on the segmentation mask may cause more token merging in background portions of the image and leave foreground portions with less token merging. Diffusion blending may generate a rectangular foreground portion of an image. saliency-based token merging may identify pixels within the rectangular foreground portion as salient or not and adjust weights within the rectangular foreground portion.

In some cases, training of one or more of the machine learning systems or networks described herein (e.g., such as the latent diffusion model 500 of FIG. 5, among various other machine learning networks) can be performed using online training, offline training, and/or various combinations of online and offline training. In some cases, online may refer to time periods during which the input data (e.g., such as received sensor data, such as received images, etc.) is processed, for instance for performance of the video content modification processing implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

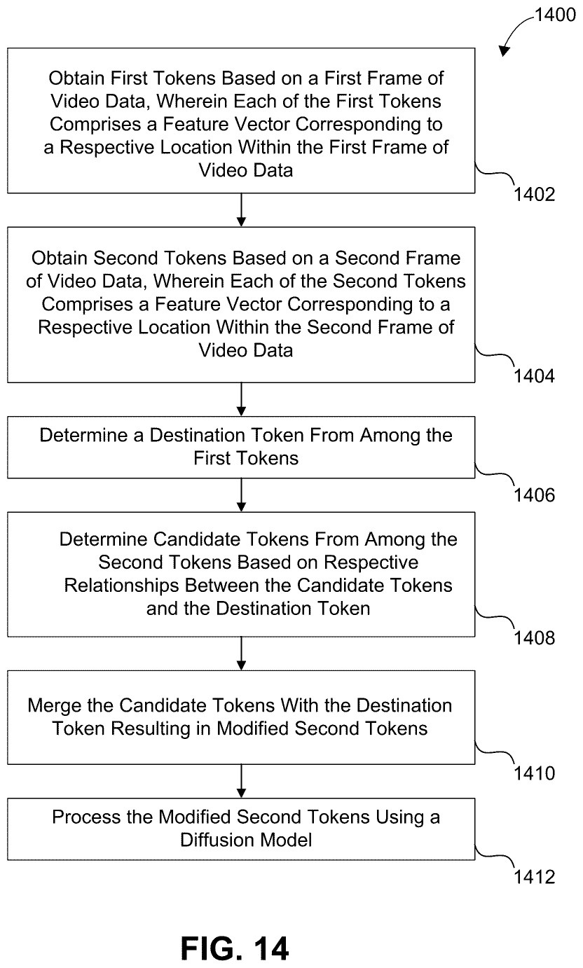

FIG. 14 is a flow diagram illustrating an example process 1400 for modifying video data, according to various aspects of the present disclosure. One or more operations of process 1400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1400. The one or more operations of process 1400 may be implemented as software components that are executed and run on one or more processors.

At block 1402, a computing device (or one or more components thereof) may obtain first tokens based on a first frame of video data, wherein each of the first tokens comprises a feature vector corresponding to a respective location within the first frame of video data. For example, system 900B of FIG. 9B may obtain tokens 922 of a frame 914 of video data. For instance system 900B may obtain the tokens illustrated in the bottom portion of column 906 of FIG. 9A and labelled as to. As another example, system 900B may obtain the tokens of frame 1012 of FIG. 10.

At block 1404, the computing device (or one or more components thereof) may obtain second tokens based on a second frame of video data, wherein each of the second tokens comprises a feature vector corresponding to a respective location within the second frame of video data. For example, system 900B of FIG. 9B may obtain tokens 924 of a frame 916 of the video data. For instance system 900B may obtain the tokens illustrated in the bottom portion of column 906 of FIG. 9A and labelled as t₁. As another example, system 900B may obtain the tokens of frame 1002 of FIG. 10.

At block 1406, the computing device (or one or more components thereof) may determine a destination token from among the first tokens. For example, system 900B may determine that some of the tokens obtained at block 1402 are destination tokens. For example, system 900B may determine that the darker gray tokens illustrated in the bottom portion of column 906 of FIG. 9A and labelled as to are destination tokens. As another example, system 900B may determine that the token 1014 of FIG. 10 is a destination token.

In some aspects, the destination token may be randomly determined from among the first tokens. For example, token merger 926 of FIG. 9B may (at block 1406) randomly select the destination token from among the tokens obtained at block 1402.

At block 1408, the computing device (or one or more components thereof) may determine candidate tokens from among the second tokens based on respective relationships between the candidate tokens and the destination token. For example, token merger 926 may determine that at least some of the lighter gray tokens illustrated in the bottom portion of column 906 of FIG. 9A and labelled as t₁ are candidate tokens. As another example, token merger 926 may determine that tokens 1006, tokens 1016, and/or tokens 1026 of FIG. 10 are candidate tokens.

In some aspects, the respective relationships between the candidate tokens and the destination token may be based on a Cosine distance between the candidate tokens and the destination token. For example, token merger 926 may determine that at least some of the lighter gray tokens illustrated in the bottom portion of column 906 of FIG. 9A and labelled as t₁ are candidate tokens based on a Cosine distance between the candidate tokens and the destination token determined at block 1406. As another example, token merger 926 may determine that tokens 1006, tokens 1016, and/or tokens 1026 of FIG. 10 are candidate tokens based on a Cosine distance between token 1014 and tokens 1006, tokens 1016, and/or tokens 1026.

At block 1410, the computing device (or one or more components thereof) may merge the candidate tokens with the destination token resulting in modified second tokens. For example, token merger 926 may merge at least some of the lighter gray tokens illustrated in the bottom portion of column 906 of FIG. 9A and labelled as t₁ with at least one destination token (e.g., at least one of the darker gray tokens illustrated in the bottom portion of column 906 of FIG. 9A and labelled as t₀). As another example, token merger 926 may merge tokens 1006, tokens 1016, and/or tokens 1026 with token 1014.

At block 1412, the computing device (or one or more components thereof) may process the modified second tokens using a diffusion model. For example, diffusion model 930 of FIG. 9B may process tokens 928 (e.g., including the tokens merged at block 1410).

In some aspects, to process the modified second tokens, the computing device (or one or more components thereof) may process unmerged tokens of the second tokens and not process the merged candidate tokens. For example, in processing the tokens, diffusion model 930 may process unmerged tokens (such as the tokens not merged at block 1410) and not process the merged tokens (such as the tokens merged at block 1410). For example, diffusion model 930 may process tokens 1008, tokens 1018, and tokens 1028 and not process tokens 1006, tokens 1016, and tokens 1026.

Column 904 and column 906 of FIG. 9A and FIG. 9B illustrate concepts related to process 1400. Additionally, FIGS. 8 and 10 illustrate concepts related to process 1400.

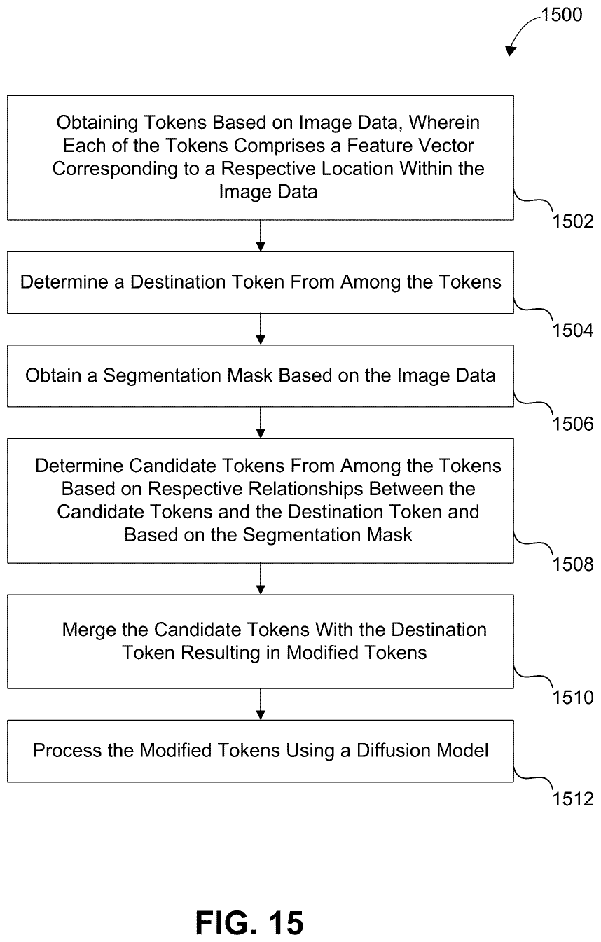

FIG. 15 is a flow diagram illustrating an example process 1500 for modifying video data, according to various aspects of the present disclosure. One or more operations of process 1500 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1500. The one or more operations of process 1500 may be implemented as software components that are executed and run on one or more processors.

At block 1502, a computing device (or one or more components thereof) may obtain tokens based on image data, wherein each of the tokens comprises a feature vector corresponding to a respective location within the image data. For example, system 900B of FIG. 9B may obtain tokens 920 of a frame 912 of video data. For instance system 900B may obtain the tokens illustrated in column 908 of FIG. 9A and labelled.

At block 1504, the computing device (or one or more components thereof) may determine a destination token from among the tokens. For example, system 900B may determine that some of the tokens obtained at block 1502 are destination tokens. For example, system 900B may determine that some of tokens 920 are destination tokens. As another example, system 900B may determine some of the tokens of column 908 are destination tokens.

In some aspects, the destination token may be randomly determined from among the first tokens.

At block 1506, the computing device (or one or more components thereof) may obtain a segmentation mask based on the image data. For example, system 900B of FIG. 9B may obtain segmentation mask 936.

In some aspects, the segmentation mask may be based on at least one of: a foreground-background segmentation; a saliency segmentation; or a cross-attention map from latent representations.

At block 1508, the computing device (or one or more components thereof) may determine candidate tokens from among the tokens based on respective relationships between the candidate tokens and the destination token and based on the segmentation mask. For example, token merger 926 may determine candidate tokens from among tokens 920 based on the relationships between the candidate tokens and the destination token (e.g., determined at block 1504).

In some aspects, the respective relationships between the candidate tokens and the destination token may be based on a Cosine distance between the candidate tokens and the destination token.

In some aspects, to determine the candidate tokens from among the tokens based on respective relationships between the candidate tokens and the destination token and based on the segmentation mask, the computing device (or one or more components thereof) may weight respective relationships between the candidate tokens and the destination token based on corresponding portions of the segmentation mask. For example, in column 908 of FIG. 9A, some tokens are identified to not be merged (e.g., identified as unmerged tokens) based on the foreground mask, which is an example of a segmentation mask.

In some aspects, the weighting causes tokens corresponding to salient portions of the image data, as identified by the segmentation mask, to be less likely to be determined to be candidate tokens.

In some aspects, the candidate tokens may be further based on a similarity threshold.

At block 1510, the computing device (or one or more components thereof) may merge the candidate tokens with the destination token resulting in modified tokens. For example, token merger 926 may merge tokens 920 to generate tokens 928.

At block 1512, the computing device (or one or more components thereof) may process the modified tokens using a diffusion model. For example, diffusion model 930 of FIG. 9B may process tokens 928 to generate frame 932.

In some aspects, to process the modified second tokens, the computing device (or one or more components thereof) may process unmerged tokens of the second tokens and not process the merged candidate tokens.

In some aspects, the image data may be, or may include, a frame of video data. The computing device (or one or more components thereof) may repeat process 1500 for further frames of the video data.

Column 908 of FIG. 9A illustrates concepts related to process 1500. Additionally, FIG. 11 illustrates concepts related to process 1500.

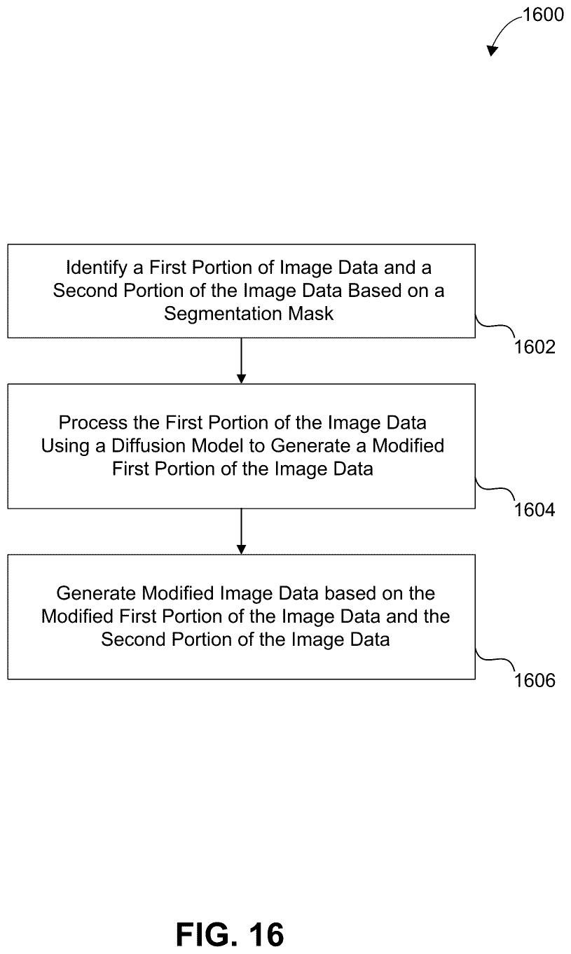

FIG. 16 is a flow diagram illustrating an example process 1600 for modifying image data, according to various aspects of the present disclosure. One or more operations of process 1600 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1600. The one or more operations of process 1600 may be implemented as software components that are executed and run on one or more processors.

At block 1602, a computing device (or one or more components thereof) may identify a first portion of image data and a second portion of the image data based on a segmentation mask. For example, diffusion model 930 may include System 1200 of FIG. 12 and/or system 1300 of FIG. 13. System 1200 or system 1300 may obtain an indication of a portion of an image. The portion of the image may relate to a region of interest and/or be based on a segmentation mask, such as a foreground-background mask.

In some aspects, the segmentation mask may be based on at least one of: a foreground-background segmentation; a saliency segmentation; or a cross-attention map from latent representations.

In some aspects, the computing device (or one or more components thereof) may crop the portion from the image. In some aspects, the portion may be rectangular.

At block 1604, the computing device (or one or more components thereof) may process the first portion of the image data using a diffusion model to generate a modified first portion of the image data. For example, system 1200 or system 1300 may process the portion of the image through several steps of a diffusion process.

At block 1606, the computing device (or one or more components thereof) may generate modified image data based on the modified first portion of the image data and the second portion of the image data. For example, system 1200 or system 1300 may generate an image based on the portion of the image modified at block 1606 and the remained of the image.

In some aspects, to generate the modified image data, the computing device (or one or more components thereof) may combine the modified first portion of the image data and the second portion of the image data resulting in modified image data. For example, system 1200 of FIG. 12 may combine the modified portion of the image with the remainder of the image.

In some aspects, to combine the modified first portion of the image data and the second portion of the image data, the computing device (or one or more components thereof) may blend pixels from the modified first portion of the image data and the second portion of the image data.

In some aspects, the first portion of the image data is processed through a first number of diffusion steps of the diffusion model to generate the modified first portion of the image data. Further, to generate the modified image data, the computing device (or one or more components thereof) may process the modified first portion of the image data and the second portion of the image data using a second number of diffusion steps of the diffusion model to generate modified image data. For example, system 1300 of FIG. 13 may process the portion through a first number of diffusion steps then process the partially-processed portion with the remainder of the image through a second number of diffusion steps.

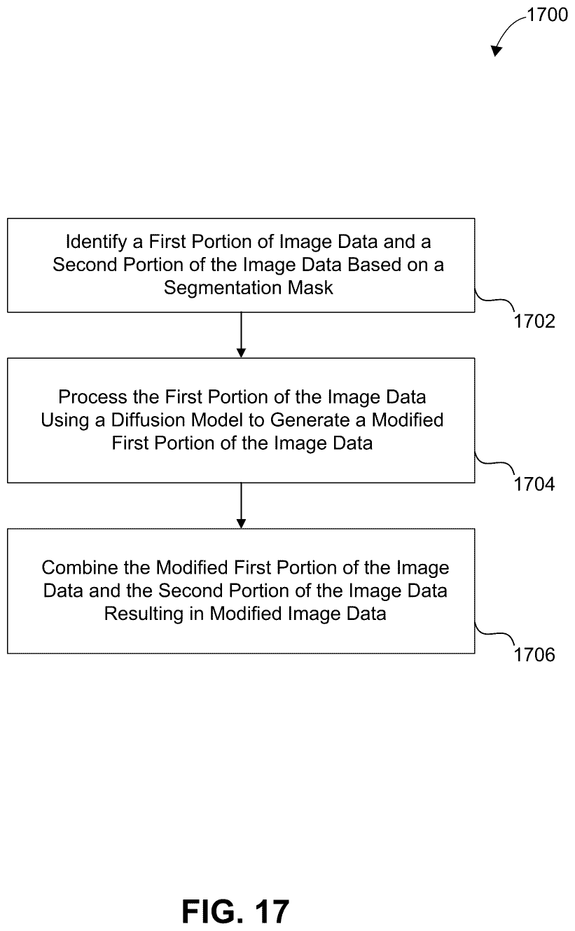

FIG. 17 is a flow diagram illustrating an example process 1700 for modifying image data, according to various aspects of the present disclosure. One or more operations of process 1400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1700. The one or more operations of process 1700 may be implemented as software components that are executed and run on one or more processors.

At block 1702, a computing device (or one or more components thereof) may identify a first portion of image data and a second portion of the image data based on a segmentation mask.

In some aspects, the segmentation mask may be based on at least one of: a foreground-background segmentation; a saliency segmentation; or a cross-attention map from latent representations.

In some aspects, the first portion of the image data may be cropped from the image data. In some aspects, the first portion of the image data may be, or may include, a rectangular portion cropped from the image data.

At block 1704, the computing device (or one or more components thereof) may process the first portion of the image data using a diffusion model to generate a modified first portion of the image data.

At block 1706, the computing device (or one or more components thereof) may combine the modified first portion of the image data and the second portion of the image data resulting in modified image data.

In some aspects, to combine the modified first portion of the image data and the second portion of the image data, the computing device (or one or more components thereof) may blend pixels from the modified first portion of the image data and the second portion of the image data.

In some aspects, the image data may be, or may include, a frame of video data. The computing device (or one or more components thereof) may repeat process 1700 for further frames of the video data.

Column 904 of FIG. 9A illustrates concepts related to process 1700. Additionally, FIG. 12 illustrates concepts related to process 1700.

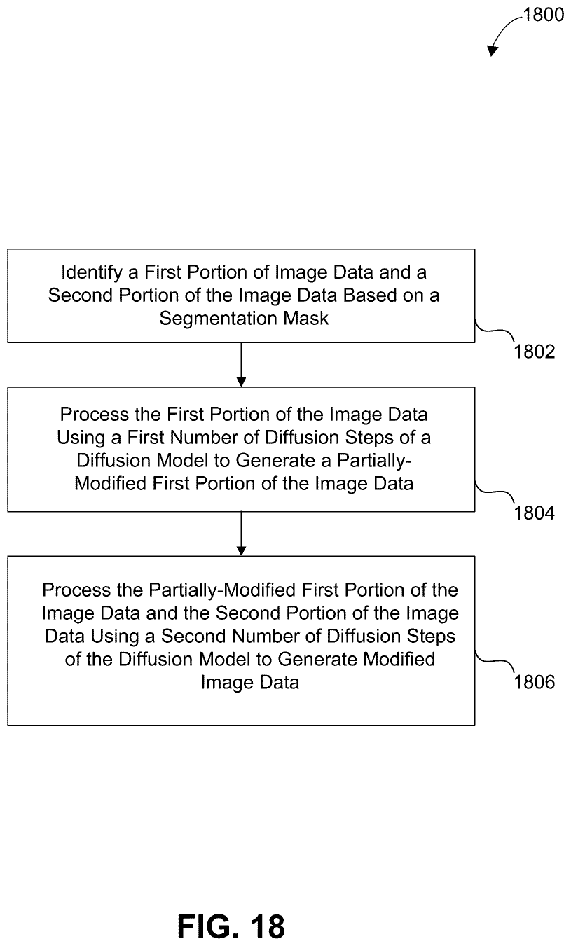

FIG. 18 is a flow diagram illustrating an example process 1800 for modifying image data, according to various aspects of the present disclosure. One or more operations of process 1800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1800. The one or more operations of process 1800 may be implemented as software components that are executed and run on one or more processors.

At block 1802, a computing device (or one or more components thereof) may identify a first portion of image data and a second portion of the image data based on a segmentation mask.

In some aspects, the segmentation mask may be based on at least one of: a foreground-background segmentation; a saliency segmentation; or a cross-attention map from latent representations.

In some aspects, the first portion of the image data may be cropped from the image data. In some aspects, the first portion of the image data may be, or may include, a rectangular portion cropped from the image data.

At block 1804, the computing device (or one or more components thereof) may process the first portion of the image data using a first number of diffusion steps of a diffusion model to generate a partially-modified first portion of the image data.

At block 1806, the computing device (or one or more components thereof) may process the partially-modified first portion of the image data and the second portion of the image data using a second number of diffusion steps of the diffusion model to generate modified image data.

In some aspects, the image data may be, or may include, a frame of video data. The computing device (or one or more components thereof) may repeat process 1800 for further frames of the video data.

Column 904 of FIG. 9A illustrates concepts related to process 1800. Additionally, FIG. 13 illustrates concepts related to process 1800.

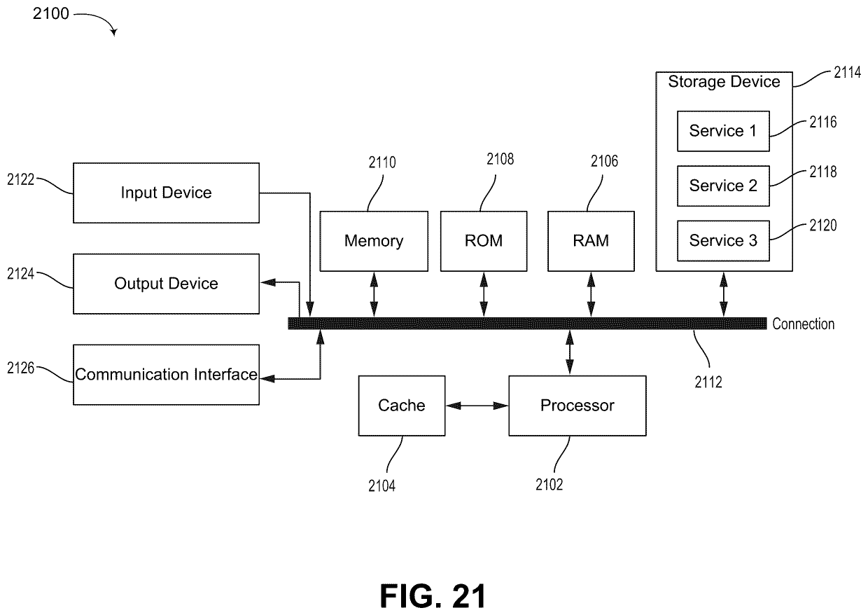

In some examples, as noted previously, the methods described herein (e.g., process 1400 of FIG. 14, process 1500 of FIG. 15, process 1600 of FIG. 16, process 1700 of FIG. 17, process 1800 of FIG. 18, and/or other methods described herein) can be performed, in whole or in part, by a computing device or apparatus. In one example, one or more of the methods can be performed by system 100 of FIG. 1, latent diffusion model 500 of FIG. 5, system 900A of FIG. 9A, or by another system or device. In another example, one or more of the methods (e.g., process 1400, process 1500, process 1600, process 1700, process 1800, and/or other methods described herein) can be performed, in whole or in part, by the computing-device architecture 2100 shown in FIG. 21. For instance, a computing device with the computing-device architecture 2100 shown in FIG. 21 can include, or be included in, the components of the system 100, latent diffusion model 500, and/or system 900A of FIG. 9A, and can implement the operations of process 1400, process 1500, process 1600, process 1700, process 1800, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1400, process 1500, process 1600, process 1700, process 1800, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1400, process 1500, process 1600, process 1700, process 1800, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

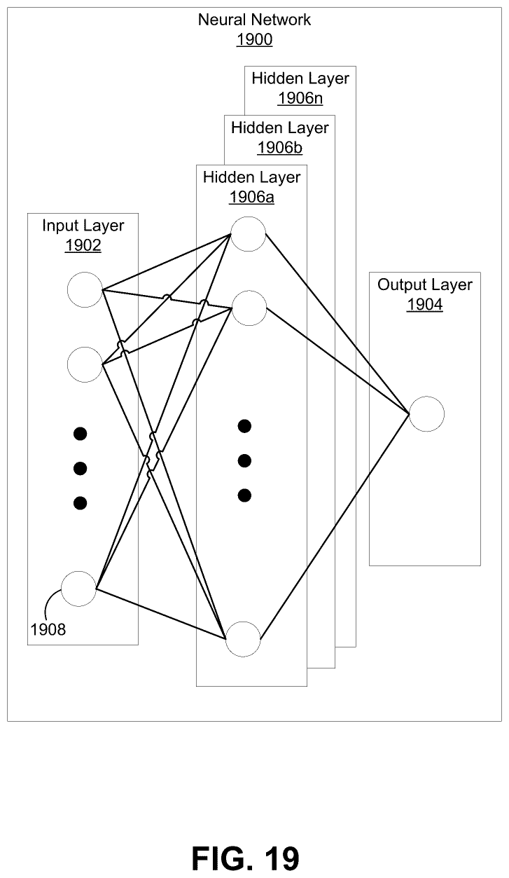

FIG. 19 is an illustrative example of a neural network 1900 (e.g., a deep-learning neural network) that can be used to implement machine-learning-based image generation, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1900 may be an example of a portion of U-Net architecture 400 of FIG. 4, latent diffusion model 500 of FIG. 5, the diffusion model of FIG. 9A, a diffusion model of the latent diffusion process of FIG. 12, a diffusion model of the latent diffusion process of FIG. 13.

An input layer 1902 includes input data. In one illustrative example, input layer 1902 can include data representing images and/or text prompts. Neural network 1900 includes multiple hidden layers hidden layers 1906a, 1906b, through 1906n. The hidden layers 1906a, 1906b, through hidden layer 1906n include “n” number of hidden layers, where “n” is an integer greater than or equal to one. The number of hidden layers can be made to include as many layers as needed for the given application. Neural network 1900 further includes an output layer 1904 that provides an output resulting from the processing performed by the hidden layers 1906a, 1906b, through 1906n. In one illustrative example, output layer 1904 can provide image latents and/or images.

Neural network 1900 may be, or may include, a multi-layer neural network of interconnected nodes. Each node can represent a piece of information. Information associated with the nodes is shared among the different layers and each layer retains information as information is processed. In some cases, neural network 1900 can include a feed-forward network, in which case there are no feedback connections where outputs of the network are fed back into itself. In some cases, neural network 1900 can include a recurrent neural network, which can have loops that allow information to be carried across nodes while reading in input.

Information can be exchanged between nodes through node-to-node interconnections between the various layers. Nodes of input layer 1902 can activate a set of nodes in the first hidden layer 1906a. For example, as shown, each of the input nodes of input layer 1902 is connected to each of the nodes of the first hidden layer 1906a. The nodes of first hidden layer 1906a can transform the information of each input node by applying activation functions to the input node information. The information derived from the transformation can then be passed to and can activate the nodes of the next hidden layer 1906b, which can perform their own designated functions. Example functions include convolutional, up-sampling, data transformation, and/or any other suitable functions. The output of the hidden layer 1906b can then activate nodes of the next hidden layer, and so on. The output of the last hidden layer 1906n can activate one or more nodes of the output layer 1904, at which an output is provided. In some cases, while nodes (e.g., node 1908) in neural network 1900 are shown as having multiple output lines, a node has a single output and all lines shown as being output from a node represent the same output value.

In some cases, each node or interconnection between nodes can have a weight that is a set of parameters derived from the training of neural network 1900. Once neural network 1900 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1900 to be adaptive to inputs and able to learn as more and more data is processed.

Neural network 1900 may be pre-trained to process the features from the data in the input layer 1902 using the different hidden layers 1906a, 1906b, through 1906n in order to provide the output through the output layer 1904. In an example in which neural network 1900 is used to identify features in images, neural network 1900 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1900 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 1900 is trained well enough so that the weights of the layers are accurately tuned.

For the example of identifying objects in images, the forward pass can include passing a training image through neural network 1900. The weights are initially randomized before neural network 1900 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1900, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1900 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1900 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - {η}^{\frac{dL}{dW}} ,$$

where w denotes a weight, wᵢ denotes the initial weight, and η denotes a learning rate. The learning rate can be set to any suitable value, with a high learning rate including larger weight updates and a lower value indicating smaller weight updates.

Neural network 1900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1900 can include any other deep network other than a CNN, such as an autoencoder, a deep belief nets (DBNs), a Recurrent Neural Networks (RNNs), among others.

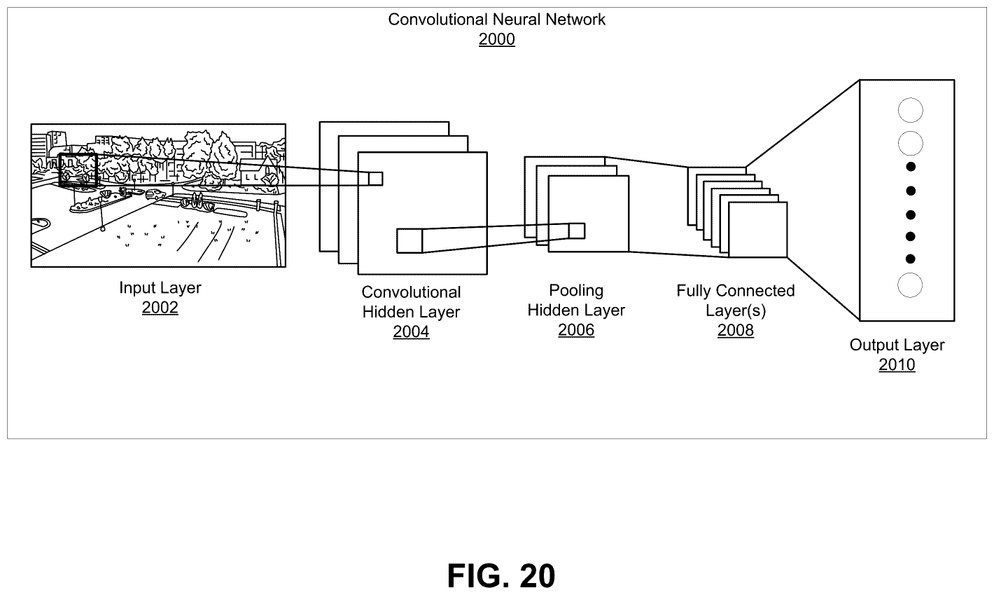

FIG. 20 is an illustrative example of a convolutional neural network (CNN) 2000. The input layer 2002 of the CNN 2000 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 2004, an optional non-linear activation layer, a pooling hidden layer 2006, and fully connected layer 2008 (which fully connected layer 2008 can be hidden) to get an output at the output layer 2010. While only one of each hidden layer is shown in FIG. 20, one of ordinary skill will appreciate that multiple convolutional hidden layers, non-linear layers, pooling hidden layers, and/or fully connected layers can be included in the CNN 2000. As previously described, the output can indicate a single class of an object or can include a probability of classes that best describe the object in the image.

The first layer of the CNN 2000 can be the convolutional hidden layer 2004. The convolutional hidden layer 2004 can analyze image data of the input layer 2002. Each node of the convolutional hidden layer 2004 is connected to a region of nodes (pixels) of the input image called a receptive field. The convolutional hidden layer 2004 can be considered as one or more filters (each filter corresponding to a different activation or feature map), with each convolutional iteration of a filter being a node or neuron of the convolutional hidden layer 2004. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 2004. Each connection between a node and a receptive field for that node learns a weight and, in some cases, an overall bias such that each node learns to analyze its particular local receptive field in the input image. Each node of the convolutional hidden layer 2004 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 2004 is due to each node of the convolutional layer being applied to its corresponding receptive field. For example, a filter of the convolutional hidden layer 2004 can begin in the top-left corner of the input image array and can convolve around the input image. As noted above, each convolutional iteration of the filter can be considered a node or neuron of the convolutional hidden layer 2004. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 2004. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 2004.

The mapping from the input layer to the convolutional hidden layer 2004 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 2004 can include several activation maps in order to identify multiple features in an image. The example shown in FIG. 20 includes three activation maps. Using three activation maps, the convolutional hidden layer 2004 can detect three different kinds of features, with each feature being detectable across the entire image.

In some examples, a non-linear hidden layer can be applied after the convolutional hidden layer 2004. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 2000 without affecting the receptive fields of the convolutional hidden layer 2004.

The pooling hidden layer 2006 can be applied after the convolutional hidden layer 2004 (and after the non-linear hidden layer when used). The pooling hidden layer 2006 is used to simplify the information in the output from the convolutional hidden layer 2004. For example, the pooling hidden layer 2006 can take each activation map output from the convolutional hidden layer 2004 and generates a condensed activation map (or feature map) using a pooling function. Max-pooling is one example of a function performed by a pooling hidden layer. Other forms of pooling functions be used by the pooling hidden layer 2006, such as average pooling, L2-norm pooling, or other suitable pooling functions. A pooling function (e.g., a max-pooling filter, an L2-norm filter, or other suitable pooling filter) is applied to each activation map included in the convolutional hidden layer 2004. In the example shown in FIG. 20, three pooling filters are used for the three activation maps in the convolutional hidden layer 2004.

In some examples, max-pooling can be used by applying a max-pooling filter (e.g., having a size of 2×2) with a stride (e.g., equal to a dimension of the filter, such as a stride of 2) to an activation map output from the convolutional hidden layer 2004. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 2004 having a dimension of 24×24 nodes, the output from the pooling hidden layer 2006 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 2000.

The final layer of connections in the network is a fully-connected layer that connects every node from the pooling hidden layer 2006 to every one of the output nodes in the output layer 2010. Using the example above, the input layer includes 28×28 nodes encoding the pixel intensities of the input image, the convolutional hidden layer 2004 includes 3×24×24 hidden feature nodes based on application of a 5×5 local receptive field (for the filters) to three activation maps, and the pooling hidden layer 2006 includes a layer of 3×12×12 hidden feature nodes based on application of max-pooling filter to 2×2 regions across each of the three feature maps. Extending this example, the output layer 2010 can include ten output nodes. In such an example, every node of the 3×12×12 pooling hidden layer 2006 is connected to every node of the output layer 2010.

The fully connected layer 2008 can obtain the output of the previous pooling hidden layer 2006 (which should represent the activation maps of high-level features) and determines the features that most correlate to a particular class. For example, the fully connected layer 2008 can determine the high-level features that most strongly correlate to a particular class and can include weights (nodes) for the high-level features. A product can be computed between the weights of the fully connected layer 2008 and the pooling hidden layer 2006 to obtain probabilities for the different classes. For example, if the CNN 2000 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 2010 can include an M-dimensional vector (in the prior example, M=10). M indicates the number of classes that the CNN 2000 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 21 illustrates an example computing-device architecture 2100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 2100 may include, implement, or be included in any or all of system 100, apparatus 600, apparatus 800, and/or image-processing system 1100. Additionally or alternatively, computing-device architecture 2100 may be configured to perform process 1000, and/or other process described herein.

The components of computing-device architecture 2100 are shown in electrical communication with each other using connection 2112, such as a bus. The example computing-device architecture 2100 includes a processing unit (CPU or processor) 2102 and computing device connection 2112 that couples various computing device components including computing device memory 2110, such as read only memory (ROM) 2108 and random-access memory (RAM) 2106, to processor 2102.

Computing-device architecture 2100 can include a cache of high-speed memory connected directly with, in close proximity to, or integrated as part of processor 2102. Computing-device architecture 2100 can copy data from memory 2110 and/or the storage device 2114 to cache 2104 for quick access by processor 2102. In this way, the cache can provide a performance boost that avoids processor 2102 delays while waiting for data. These and other modules can control or be configured to control processor 2102 to perform various actions. Other computing device memory 2110 may be available for use as well. Memory 2110 can include multiple different types of memory with different performance characteristics. Processor 2102 can include any general-purpose processor and a hardware or software service, such as service 1 2116, service 2 2118, and service 3 2120 stored in storage device 2114, configured to control processor 2102 as well as a special-purpose processor where software instructions are incorporated into the processor design. Processor 2102 may be a self-contained system, containing multiple cores or processors, a bus, memory controller, cache, etc. A multi-core processor may be symmetric or asymmetric.

To enable user interaction with the computing-device architecture 2100, input device 2122 can represent any number of input mechanisms, such as a microphone for speech, a touch-sensitive screen for gesture or graphical input, keyboard, mouse, motion input, speech and so forth. Output device 2124 can also be one or more of a number of output mechanisms known to those of skill in the art, such as a display, projector, television, speaker device, etc. In some instances, multimodal computing devices can enable a user to provide multiple types of input to communicate with computing-device architecture 2100. Communication interface 2126 can generally govern and manage the user input and computing device output. There is no restriction on operating on any particular hardware arrangement and therefore the basic features here may easily be substituted for improved hardware or firmware arrangements as they are developed.

Storage device 2114 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 2106, read only memory (ROM) 2108, and hybrids thereof. Storage device 2114 can include services 2116, 2118, and 2120 for controlling processor 2102. Other hardware or software modules are contemplated. Storage device 2114 can be connected to the computing device connection 2112. In one aspect, a hardware module that performs a particular function can include the software component stored in a computer-readable medium in connection with the necessary hardware components, such as processor 2102, connection 2112, output device 2124, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory (or one or more memories), at least one processor (or one or more processors), at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for modifying video data, the apparatus comprising: one or more memories configured to store the video data; and one or more processors coupled to the one or more memories and configured to: obtain first tokens based on a first frame of the video data, wherein each of the first tokens comprises a feature vector corresponding to a respective location within the first frame of video data; obtain second tokens based on a second frame of video data, wherein each of the second tokens comprises a feature vector corresponding to a respective location within the second frame of video data; determine a destination token from among the first tokens; determine candidate tokens from among the second tokens based on respective relationships between the candidate tokens and the destination token; merge the candidate tokens with the destination token resulting in modified second tokens; and process the modified second tokens using a diffusion model.

Aspect 2. The apparatus of Aspect 1, wherein the destination token is randomly determined from among the first tokens.

Aspect 3. The apparatus of any one of Aspects 1 or 2, wherein the respective relationships between the candidate tokens and the destination token are based on a Cosine distance between the candidate tokens and the destination token.

Aspect 4. The apparatus of any one of Aspects 1 to 3, wherein, to process the modified second tokens, the one or more processors are configured to process unmerged tokens of the second tokens and not process the merged candidate tokens.

Aspect 5. The apparatus of any one of Aspects 1 to 4, further comprising at least one camera configured to capture the first frame and the second frame of the video data.

Aspect 6. An apparatus for modifying video data, the apparatus comprising: one or more memories configured to store the video data; and one or more processors coupled to the one or more memories and configured to perform operations comprising: obtain a plurality of tokens comprising a respective set of tokens for each frame of a plurality of frames of the video data; identify a destination token from among the plurality of tokens; determine candidate tokens from among the plurality of tokens based on respective relationships between the candidate tokens and the destination token; merge the candidate tokens with the destination token resulting in modified second tokens; and process the modified second tokens using a diffusion model.

Aspect 7. The apparatus of Aspect 6, wherein the plurality of frames of the video data comprises a pool of frames of the video data and wherein the one or more processors are configured to repeat the operations for further pools of frames of the video data.

Aspect 8. The apparatus of Aspect 7, wherein the plurality of frames of the video data comprises a sliding window of frames of the video data and wherein the one or more processors are configured to repeat the operations for sliding windows of frames of the video data.

Aspect 9. The apparatus of any one of Aspects 6 to 8, wherein the plurality of frames of the video data comprises all frames of the video data.

Aspect 10. The apparatus of any one of Aspects 6 to 9, further comprising at least one camera configured to capture the plurality of frames of the video data.

Aspect 11. An apparatus for modifying image data, the apparatus comprising: one or more memories configured to store the image data; and one or more processors coupled to the one or more memories and configured to perform operations comprising: obtain tokens based on image data, wherein each of the tokens comprises a feature vector corresponding to a respective location within the image data; determine a destination token from among the tokens; obtain a segmentation mask based on the image data; determine candidate tokens from among the tokens based on respective relationships between the candidate tokens and the destination token and based on the segmentation mask; merge the candidate tokens with the destination token resulting in modified tokens; and process the modified tokens using a diffusion model.

Aspect 12. The apparatus of Aspect 11, wherein the segmentation mask is based on at least one of: a foreground-background segmentation; a saliency segmentation; or a cross-attention map from latent representations.

Aspect 13. The apparatus of any one of Aspects 11 or 12, wherein, to determine the candidate tokens from among the tokens based on respective relationships between the candidate tokens and the destination token and based on the segmentation mask, the one or more processors are configured to: weight respective relationships between the candidate tokens and the destination token based on corresponding portions of the segmentation mask.

Aspect 14. The apparatus of Aspect 13, wherein the weighting causes tokens corresponding to salient portions of the image data, as identified by the segmentation mask, to be less likely to be determined to be candidate tokens.

Aspect 15. The apparatus of any one of Aspects 11 to 14, wherein the candidate tokens are further based on a similarity threshold.

Aspect 16. The apparatus of any one of Aspects 11 to 15, wherein the respective relationships between the candidate tokens and the destination token are based on a Cosine distance between the candidate tokens and the destination token.

Aspect 17. The apparatus of any one of Aspects 11 to 16, wherein the image data comprises a frame of video data and wherein the one or more processors are configured to repeat the operations for further frames of the video data.

Aspect 18. The apparatus of any one of Aspects 11 to 17, further comprising at least one camera configured to capture the image data.

Aspect 19. An apparatus for modifying image data, the apparatus comprising: one or more memories configured to store the image data; and one or more processors coupled to the one or more memories and configured to: identify a first portion of image data and a second portion of the image data based on a segmentation mask; process the first portion of the image data using a diffusion model to generate a modified first portion of the image data; and combine the modified first portion of the image data and the second portion of the image data resulting in modified image data.

Aspect 20. The apparatus of Aspect 19, wherein the segmentation mask is based on at least one of: a foreground-background segmentation; a saliency segmentation; or a cross-attention map from latent representations.

Aspect 21. The apparatus of any one of Aspects 19 or 20, wherein, to combine the modified first portion of the image data and the second portion of the image data, the one or more processors are configured to blend pixels from the modified first portion of the image data and the second portion of the image data.

Aspect 22. The apparatus of any one of Aspects 19 to 21, wherein the first portion of the image data is cropped from the image data.

Aspect 23. The apparatus of any one of Aspects 19 to 22, wherein the first portion of the image data comprises a rectangular portion cropped from the image data.

Aspect 24. The apparatus of any one of Aspects 19 to 23, further comprising at least one camera configured to capture the image data.

Aspect 25. An apparatus for modifying image data, the apparatus comprising: one or more memories configured to store the image data; and one or more processors coupled to the one or more memories and configured to: identify a first portion of image data and a second portion of the image data based on a segmentation mask; process the first portion of the image data using a first number of diffusion steps of a diffusion model to generate a partially-modified first portion of the image data; and process the partially-modified first portion of the image data and the second portion of the image data using a second number of diffusion steps of the diffusion model to generate modified image data.

Aspect 26. The apparatus of Aspect 25, further comprising at least one camera configured to capture the image data.

Aspect 27. A method for modifying video data, the method comprising: obtaining first tokens based on a first frame of video data, wherein each of the first tokens comprises a feature vector corresponding to a respective location within the first frame of video data; obtaining second tokens based on a second frame of video data, wherein each of the second tokens comprises a feature vector corresponding to a respective location within the second frame of video data; determining a destination token from among the first tokens; determining candidate tokens from among the second tokens based on respective relationships between the candidate tokens and the destination token; merging the candidate tokens with the destination token resulting in modified second tokens; and processing the modified second tokens using a diffusion model.

Aspect 28. The method of Aspect 27, wherein the destination token is randomly determined from among the first tokens.

Aspect 29. The method of any one of Aspects 27 or 28, wherein the respective relationships between the candidate tokens and the destination token are based on a Cosine distance between the candidate tokens and the destination token.

Aspect 30. The method of any one of Aspects 27 to 29, wherein processing the modified second tokens comprises processing unmerged tokens of the second tokens and not processing the merged candidate tokens.

Aspect 31. A method for modifying video data, the method comprising: obtaining a plurality of tokens comprising a respective set of tokens for each frame of a plurality of frames of video data; identifying a destination token from among the plurality of tokens; determining candidate tokens from among the plurality of tokens based on respective relationships between the candidate tokens and the destination token; merging the candidate tokens with the destination token resulting in modified second tokens; and processing the modified second tokens using a diffusion model.

Aspect 32. The method of Aspect 31, wherein the plurality of frames of the video data comprises a pool of frames of the video data and wherein the method is repeated for further pools of frames of the video data.

Aspect 33. The method of any one of Aspects 31 or 32, wherein the plurality of frames of the video data comprises a sliding window of frames of the video data and wherein the method is repeated for sliding windows of frames of the video data.

Aspect 34. The method of any one of Aspects 31 to 33, wherein the plurality of frames of the video data comprises all frames of the video data.

Aspect 35. A method for modifying image data, the method comprising: obtaining tokens based on image data, wherein each of the tokens comprises a feature vector corresponding to a respective location within the image data; determining a destination token from among the tokens; obtaining a segmentation mask based on the image data; determining candidate tokens from among the tokens based on respective relationships between the candidate tokens and the destination token and based on the segmentation mask; merging the candidate tokens with the destination token resulting in modified tokens; and processing the modified tokens using a diffusion model.

Aspect 36. The method of Aspect 35, wherein the segmentation mask is based on at least one of: a foreground-background segmentation; a saliency segmentation; or a cross-attention map from latent representations.

Aspect 37. The method of any one of Aspects 35 or 36, wherein determining the candidate tokens from among the tokens based on respective relationships between the candidate tokens and the destination token and based on the segmentation mask further comprises: weighting respective relationships between the candidate tokens and the destination token based on corresponding portions of the segmentation mask.

Aspect 38. The method of Aspect 37, wherein the weighting causes tokens corresponding to salient portions of the image data, as identified by the segmentation mask, to be less likely to be determined to be candidate tokens.

Aspect 39. The method of any one of Aspects 35 to 38, wherein the candidate tokens are further based on a similarity threshold.

Aspect 40. The method of any one of Aspects 35 to 39, wherein the respective relationships between the candidate tokens and the destination token are based on a Cosine distance between the candidate tokens and the destination token.

Aspect 41. The method of any one of Aspects 35 to 40, wherein the image data comprises a frame of video data and the method is repeated for further frames of the video data.

Aspect 42. A method for modifying image data, the method comprising: identifying a first portion of image data and a second portion of the image data based on a segmentation mask; processing the first portion of the image data using a diffusion model to generate a modified first portion of the image data; and combining the modified first portion of the image data and the second portion of the image data resulting in modified image data.

Aspect 43. The method of Aspect 42, wherein the segmentation mask is based on at least one of: a foreground-background segmentation; a saliency segmentation; or a cross-attention map from latent representations.

Aspect 44. The method of any one of Aspects 42 or 43, wherein combining the modified first portion of the image data and the second portion of the image data comprises blending pixels from the modified first portion of the image data and the second portion of the image data.

Aspect 45. The method of any one of Aspects 42 to 44, wherein the first portion of the image data is cropped from the image data.

Aspect 46. The method of any one of Aspects 42 to 44, wherein the first portion of the image data comprises a rectangular portion cropped from the image data.

Aspect 47. A method for modifying image data, the method comprising: identifying a first portion of image data and a second portion of the image data based on a segmentation mask; processing the first portion of the image data using a first number of diffusion steps of a diffusion model to generate a partially-modified first portion of the image data; and processing the partially-modified first portion of the image data and the second portion of the image data using a second number of diffusion steps of the diffusion model to generate modified image data.

Aspect 48. A non-transitory computer-readable storage medium having stored thereon instructions that, when executed by one or more processors, cause the one or more processors to perform operations according to any of Aspects 27 to 47.

Aspect 49. An apparatus for providing virtual content for display, the apparatus comprising one or more means for perform operations according to any of aspects 27 to 47.

Aspect 50. An apparatus for modifying video data, the apparatus comprising: one or more memories configured to store the video data; and one or more processors coupled to the one or more memories and configured to: obtain first tokens based on a first frame of the video data, wherein each of the first tokens comprises a feature vector corresponding to a respective location within the first frame of video data; obtain second tokens based on a second frame of video data, wherein each of the second tokens comprises a feature vector corresponding to a respective location within the second frame of video data; determine a destination token from among the first tokens; determine candidate tokens from among the second tokens based on respective relationships between the candidate tokens and the destination token; merge the candidate tokens with the destination token resulting in modified second tokens; and process the modified second tokens using a diffusion model.

Aspect 51. The apparatus of aspect 50, wherein the respective relationships between the candidate tokens and the destination token are based on a Cosine distance between the candidate tokens and the destination token.

Aspect 52. The apparatus of aspect 50, wherein, to process the modified second tokens, the one or more processors are configured to process unmerged tokens of the second tokens and not process the merged candidate tokens.

Aspect 53. The apparatus of aspect 50, wherein the one or more processors is configured to: identify a first group of frames of the video data, the first group of frames comprising the first frame of the video data and the second frame of the video data; identify additional group of frames of the video data; determine additional modified tokens based on the additional group of frames of the video data; and process the additional modified tokens using the diffusion model.

Aspect 54. The apparatus of aspect 53, wherein the additional group of frames of video data comprises a pool of frames.

Aspect 55. The apparatus of aspect 53, wherein the additional group of frames of video data comprises a sliding window of frames.

Aspect 56. An apparatus for modifying image data, the apparatus comprising: one or more memories configured to store the image data; and one or more processors coupled to the one or more memories and configured to: obtain tokens based on image data, wherein each of the tokens comprises a feature vector corresponding to a respective location within the image data; determine a destination token from among the tokens; obtain a segmentation mask based on the image data; determine candidate tokens from among the tokens based on respective relationships between the candidate tokens and the destination token and based on the segmentation mask; merge the candidate tokens with the destination token resulting in modified tokens; and process the modified tokens using a diffusion model.

Aspect 57. The apparatus of aspect 56, wherein the segmentation mask is based on at least one of: a foreground-background segmentation; a saliency segmentation; or a cross-attention map from latent representations.

Aspect 58. The apparatus of aspect 56, wherein, to determine the candidate tokens from among the tokens based on respective relationships between the candidate tokens and the destination token and based on the segmentation mask, the one or more processors are configured to: weight respective relationships between the candidate tokens and the destination token based on corresponding portions of the segmentation mask.

Aspect 59. The apparatus of aspect 58, wherein the weighting causes tokens corresponding to salient portions of the image data, as identified by the segmentation mask, to be less likely to be determined to be candidate tokens.

Aspect 60. The apparatus of aspect 56, wherein the candidate tokens are further based on a similarity threshold.

Aspect 61. The apparatus of aspect 56, wherein the respective relationships between the candidate tokens and the destination token are based on a Cosine distance between the candidate tokens and the destination token.

Aspect 62. The apparatus of aspect 56, wherein the image data comprises a frame of video data and wherein the one or more processors are configured to: determine additional modified tokens based on additional frames of the video data; and process the additional modified tokens using the diffusion model.

Aspect 63. An apparatus for modifying image data, the apparatus comprising: one or more memories configured to store the image data; and one or more processors coupled to the one or more memories and configured to: identify a first portion of image data and a second portion of the image data based on a segmentation mask; process the first portion of the image data using a diffusion model to generate a modified first portion of the image data; and generate modified image data based on the modified first portion of the image data and the second portion of the image data.

Aspect 64. The apparatus of aspect 63, wherein, to generate the modified image data, the one or more processors is configured to combine the modified first portion of the image data and the second portion of the image data resulting in modified image data.

Aspect 65. The apparatus of aspect 63, wherein: the first portion of the image data is processed through a first number of diffusion steps of the diffusion model to generate the modified first portion of the image data; to generate the modified image data, the one or more processors is configured to process the modified first portion of the image data and the second portion of the image data using a second number of diffusion steps of the diffusion model to generate modified image data.

Aspect 66. The apparatus of aspect 63, wherein the segmentation mask is based on at least one of: a foreground-background segmentation; a saliency segmentation; or a cross-attention map from latent representations.

Aspect 67. The apparatus of aspect 63, wherein, to combine the modified first portion of the image data and the second portion of the image data, the one or more processors are configured to blend pixels from the modified first portion of the image data and the second portion of the image data.

Aspect 68. The apparatus of aspect 63, wherein the first portion of the image data is cropped from the image data.

Aspect 69. The apparatus of aspect 63, wherein the first portion of the image data comprises a rectangular portion cropped from the image data.

Aspect 70. A method for modifying video data, the method comprising: obtaining first tokens based on a first frame of the video data, wherein each of the first tokens comprises a feature vector corresponding to a respective location within the first frame of video data; obtaining second tokens based on a second frame of video data, wherein each of the second tokens comprises a feature vector corresponding to a respective location within the second frame of video data; determining a destination token from among the first tokens; determining candidate tokens from among the second tokens based on respective relationships between the candidate tokens and the destination token; merging the candidate tokens with the destination token resulting in modified second tokens; and processing the modified second tokens using a diffusion model.

Aspect 71. The method of aspect 70, wherein the respective relationships between the candidate tokens and the destination token are based on a Cosine distance between the candidate tokens and the destination token.

Aspect 72. The method of aspect 70, wherein processing the modified second tokens comprises processing unmerged tokens of the second tokens and not processing the merged candidate tokens.

Aspect 73. The method of aspect 70, further comprising: identifying a first group of frames of the video data, the first group of frames comprising the first frame of the video data and the second frame of the video data; identifying additional group of frames of the video data; determining additional modified tokens based on the additional group of frames of the video data; and processing the additional modified tokens using the diffusion model.

Aspect 74. The method of aspect 73, wherein the additional group of frames of video data comprises a pool of frames.

Aspect 75. The method of aspect 73, wherein the additional group of frames of video data comprises a sliding window of frames.

Aspect 76. A method for modifying image data, the method comprising: obtaining tokens based on image data, wherein each of the tokens comprises a feature vector corresponding to a respective location within the image data; determining a destination token from among the tokens; obtaining a segmentation mask based on the image data; determining candidate tokens from among the tokens based on respective relationships between the candidate tokens and the destination token and based on the segmentation mask; merging the candidate tokens with the destination token resulting in modified tokens; and processing the modified tokens using a diffusion model.

Aspect 77. The method of aspect 76, wherein the segmentation mask is based on at least one of: a foreground-background segmentation; a saliency segmentation; or a cross-attention map from latent representations.

Aspect 78. The method of aspect 76, wherein determining the candidate tokens from among the tokens based on respective relationships between the candidate tokens and the destination token and based on the segmentation mask, comprises weighting respective relationships between the candidate tokens and the destination token based on corresponding portions of the segmentation mask.

Aspect 79. The method of aspect 78, wherein the weighting causes tokens corresponding to salient portions of the image data, as identified by the segmentation mask, to be less likely to be determined to be candidate tokens.

Aspect 80. The method of aspect 76, wherein the candidate tokens are further based on a similarity threshold.

Aspect 81. The method of aspect 76, wherein the respective relationships between the candidate tokens and the destination token are based on a Cosine distance between the candidate tokens and the destination token.

Aspect 82. The method of aspect 76, wherein the image data comprises a frame of video data, further comprising: determining additional modified tokens based on additional frames of the video data; and processing the additional modified tokens using the diffusion model.

Aspect 83. A method for modifying image data, the method comprising: identifying a first portion of image data and a second portion of the image data based on a segmentation mask; processing the first portion of the image data using a diffusion model to generate a modified first portion of the image data; and generating modified image data based on the modified first portion of the image data and the second portion of the image data.

Aspect 84. The method of aspect 83, wherein generating the modified image data comprises combining the modified first portion of the image data and the second portion of the image data resulting in modified image data.

Aspect 85. The method of aspect 83, wherein: the first portion of the image data is processed through a first number of diffusion steps of the diffusion model to generate the modified first portion of the image data; and generating the modified image data comprises processing the modified first portion of the image data and the second portion of the image data using a second number of diffusion steps of the diffusion model to generate modified image data.

Aspect 86. The method of aspect 83, wherein the segmentation mask is based on at least one of: a foreground-background segmentation; a saliency segmentation; or a cross-attention map from latent representations.

Aspect 87. The method of aspect 83, wherein combining the modified first portion of the image data and the second portion of the image data comprises blending pixels from the modified first portion of the image data and the second portion of the image data.

Aspect 88. The method of aspect 83, wherein the first portion of the image data is cropped from the image data.

Aspect 89. The method of aspect 83, wherein the first portion of the image data comprises a rectangular portion cropped from the image data.

Aspect 90. A non-transitory computer-readable storage medium having stored thereon instructions that, when executed by at least one processor, cause the at least one processor to perform operations according to any of aspects 70 to 89.

Aspect 91. An apparatus for providing virtual content for display, the apparatus comprising one or more means for perform operations according to any of aspects 70 to 89.

What is claimed is:

1. An apparatus for modifying video data, the apparatus comprising:
one or more memories configured to store the video data; and
one or more processors coupled to the one or more memories and configured to:
obtain first tokens based on a first frame of the video data, wherein each of the first tokens comprises a feature vector corresponding to a respective location within the first frame of video data;
obtain second tokens based on a second frame of video data, wherein each of the second tokens comprises a feature vector corresponding to a respective location within the second frame of video data;
determine a destination token from among the first tokens;
determine candidate tokens from among the second tokens based on respective relationships between the candidate tokens and the destination token;
merge the candidate tokens with the destination token resulting in modified second tokens; and
process the modified second tokens using a diffusion model.

2. The apparatus of claim 1, wherein the respective relationships between the candidate tokens and the destination token are based on a Cosine distance between the candidate tokens and the destination token.

3. The apparatus of claim 1, wherein, to process the modified second tokens, the one or more processors are configured to process unmerged tokens of the second tokens and not process the merged candidate tokens.

4. The apparatus of claim 1, wherein the one or more processors is configured to:
identify a first group of frames of the video data, the first group of frames comprising the first frame of the video data and the second frame of the video data;
identify additional group of frames of the video data;
determine additional modified tokens based on the additional group of frames of the video data; and
process the additional modified tokens using the diffusion model.

5. The apparatus of claim 4, wherein the additional group of frames of video data comprises a pool of frames.

6. The apparatus of claim 4, wherein the additional group of frames of video data comprises a sliding window of frames.

7. The apparatus of claim 1, wherein the one or more processors is configured to:
generate, using the diffusion model based on the modified second tokens, an output image for display.

8. The apparatus of claim 7, further comprising a display configured to display the output image.

9. The apparatus of claim 1, further comprising at least one camera configured to capture the first frame and the second frame of the video data.

10. An apparatus for modifying image data, the apparatus comprising:
one or more memories configured to store the image data; and
one or more processors coupled to the one or more memories and configured to:
obtain tokens based on image data, wherein each of the tokens comprises a feature vector corresponding to a respective location within the image data;
determine a destination token from among the tokens;
obtain a segmentation mask based on the image data;
determine candidate tokens from among the tokens based on respective relationships between the candidate tokens and the destination token and based on the segmentation mask;
merge the candidate tokens with the destination token resulting in modified tokens; and
process the modified tokens using a diffusion model.

11. The apparatus of claim 10, wherein the segmentation mask is based on at least one of:
a foreground-background segmentation;
a saliency segmentation; or
a cross-attention map from latent representations.

12. The apparatus of claim 10, wherein, to determine the candidate tokens from among the tokens based on respective relationships between the candidate tokens and the destination token and based on the segmentation mask, the one or more processors are configured to:
weight respective relationships between the candidate tokens and the destination token based on corresponding portions of the segmentation mask.

13. The apparatus of claim 12, wherein the weighting causes tokens corresponding to salient portions of the image data, as identified by the segmentation mask, to be less likely to be determined to be candidate tokens.

14. The apparatus of claim 10, wherein the candidate tokens are further based on a similarity threshold.

15. The apparatus of claim 10, wherein the respective relationships between the candidate tokens and the destination token are based on a Cosine distance between the candidate tokens and the destination token.

16. The apparatus of claim 10, wherein the image data comprises a frame of video data and wherein the one or more processors are configured to:
determine additional modified tokens based on additional frames of the video data; and
process the additional modified tokens using the diffusion model.

17. The apparatus of claim 10, wherein the one or more processors is configured to:
generate, using the diffusion model based on the modified tokens, an output image for display.

18. The apparatus of claim 17, further comprising a display configured to display the output image.

19. The apparatus of claim 10, further comprising at least one camera configured to capture the image data.

20. An apparatus for modifying image data, the apparatus comprising:
one or more memories configured to store the image data; and
one or more processors coupled to the one or more memories and configured to:
identify a first portion of image data and a second portion of the image data based on a segmentation mask;
process the first portion of the image data using a diffusion model to generate a modified first portion of the image data; and
generate modified image data based on the modified first portion of the image data and the second portion of the image data.

21. The apparatus of claim 20, wherein, to generate the modified image data, the one or more processors is configured to combine the modified first portion of the image data and the second portion of the image data resulting in modified image data.

22. The apparatus of claim 20, wherein:
the first portion of the image data is processed through a first number of diffusion steps of the diffusion model to generate the modified first portion of the image data; and
to generate the modified image data, the one or more processors is configured to process the modified first portion of the image data and the second portion of the image data using a second number of diffusion steps of the diffusion model to generate modified image data.

23. The apparatus of claim 20, wherein the segmentation mask is based on at least one of:
a foreground-background segmentation;
a saliency segmentation; or
a cross-attention map from latent representations.

24. The apparatus of claim 20, wherein, to combine the modified first portion of the image data and the second portion of the image data, the one or more processors are configured to blend pixels from the modified first portion of the image data and the second portion of the image data.

25. The apparatus of claim 20, wherein the first portion of the image data is cropped from the image data.

26. The apparatus of claim 20, wherein the first portion of the image data comprises a rectangular portion cropped from the image data.

27. The apparatus of claim 20, further comprising at least one camera configured to capture the image data.

28. The apparatus of claim 20, further comprising a display configured to display the modified image data.
